(19) United States
(12) Patent Application Publication
(10) Pub. No.: US 2026/0193422 A1
(43) Pub. Date: Jul. 9, 2026

(54) EMULSION OF ALKOXY-FUNCTIONAL SILSESQUIOXANE RESIN AND PROCESSES FOR THE PREPARATION AND USE THEREOF

(71) Applicant: Dow Silicones Corporation, Midland, MI (US)

(72) Inventors: Steven Swier, Midland, MI (US); Stephan Ugazio, Seneffe (BE)

(21) Appl. No.: 19/132,953

(22) PCT Filed: Dec. 11, 2023
(86) PCT No.: PCT/US2023/083282

§ 371 Date: May 27, 2025

Related U.S. Application Data
(60) Provisional application No. 63/453,265, filed on Mar. 20, 2023.

(51) Int. Cl. C08J 3/05; B05D 3/10; C09D 5/02; C09D 183/04

(52) U.S. Cl. CPC C08J 3/05; B05D 3/108; C09D 5/028; C09D 183/04; B05D 2401/20; B05D 2518/10; C08J 2383/04

(57) ABSTRACT

An alkoxy-functional silsesquioxane resin and hydrosilylation reaction processes for its preparation are provided. The alkoxy-functional silsesquioxane resin is a liquid under ambient conditions and is useful in solvent-borne, solventless, and water-borne curable compositions.

### CROSS REFERENCE TO RELATED APPLICATIONS

This application claims the benefit of U.S. Provisional Patent Application Ser. No. 63/453,265 filed on 20 Mar. 2023 under 35 U.S.C. § 119 (e). U.S. Provisional Patent Application Ser. No. 63/453,265 is hereby incorporated by reference.

### FIELD

This invention relates to an emulsion comprising an alkoxy-functional silsesquioxane resin, and processes for preparation and use of the emulsion. More particularly, the emulsion may be used in coating applications, such as paints.

### INTRODUCTION

The coatings and paints industries face pressures to reduce the use of volatile organic compounds (VOCs) for more environmentally friendly solutions. Consequently, both solvent free liquid products and water-borne (WB) products are desirable to leverage siloxane resin benefits in high performance applications. For example, U.S. Pat. No. 11,248,119 to DiGiovanni et al. discloses an emulsion, composition comprising same, film formed therewith, and related methods. Although aqueous systems like emulsions of silicone resin in water would be a logical choice to reduce the use of VOCs, aqueous emulsions of silicone resins suffer from some considerable drawbacks that need to be resolved. Replacing film forming solvent-borne (SB) formulations by WB alternatives is a challenge because the film formation process is different. For SB products, solvent evaporation and film formation takes place efficiently, which explains their relatively fast “cure time”. For WB dispersions, water evaporation and coalescence of the silicone resin need to take place before cure, which undesirably increases the cure time, and thus decreases productivity. Subsequent cure occurs through hydrolysis and condensation similar to the SB systems. Solvent-free liquid silicone resins typically suffer from slower cure times because intrinsically lower glass transition resins need to be used, which are undesirable for the end product coating performance.

Therefore, there is an industry need to improve the cure of siloxane resins delivered in emulsions.

### SUMMARY

An emulsion comprises an alkoxy-functional silsesquioxane resin, water, and a surfactant. Processes for the preparation and use of the emulsion are provided. The emulsion is suitable for in coating applications such as paints.

### DETAILED DESCRIPTION

The emulsion introduced above comprises a discontinuous phase dispersed in a continuous phase. The emulsion comprises a non-aqueous (silicone) phase, which is typically the discontinuous phase of the emulsion (but may alternatively be the continuous phase). The non-aqueous phase comprises an alkoxy-functional silsesquioxane resin. The emulsion further comprises an aqueous phase, which is typically the continuous phase of the emulsion (but may be the discontinuous phase when the non-aqueous phase is the continuous phase).

The alkoxy-functional silsesquioxane resin comprises unit formula: (R²₃SiO_{1/2})_{c}(R²₂SiO_{2/2})_{d}(R²SiO_{3/2})ₑ(ZO_{1/2})_{f}(HO_{1/2})_{g}; where each R² is independently selected from the group consisting of an alkyl group and a group of formula (I)

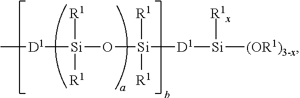

where in formula (I), each R¹ is an independently selected alkyl group, each D¹ is an independently selected alkylene group, subscripts a, b, and x are integers with values such that subscript a is 1 or 2, subscript b is 0 or 1, and subscript x is 0 or 1; with the proviso that an average of 5 mol % to 25 mol % the groups R², per molecule, have formula (I); subscripts c, d, and e represent mole fractions of each unit in the alkoxy-functional silsesquioxane resin and subscripts c, d, and e have values such that 0≤c≤0.25, 0≤d≤0.20, 0.55<e≤1, and a quantity (c+d+e)=1; each Z is an independently selected alkyl group; and subscript f represents a molar amount of alkoxy groups in the alkoxy-functional silsesquioxane resin, and subscript g represents a molar amount of hydroxyl groups in the alkoxy-functional silsesquioxane resin, and subscripts f and g have values such that 0.01≤f≤0.70; 0≤g≤0.05; and 0.02≤(f+g)≤0.75.

In the unit formula above, subscripts c, d, and e represent mole fractions of each unit in the alkoxy-functional silsesquioxane resin. A quantity (c+d+e)=1. Subscripts c, d, and e have values such that 0≤c≤0.25, 0≤d≤0.20, and 0.55<e≤1. Subscript c may be 0, alternatively >0, alternatively at least 0.100, alternatively at least 0.101, alternatively at least 0.102, alternatively at least 0.110, alternatively at least 0.120, and alternatively at least 0.130; while at the same time, subscript c may be up to 0.300, alternatively up to 0.250, alternatively up to 0.240, alternatively up to 0.200, and alternatively up to 0.150 alternatively up to 0.110. Alternatively, subscript c may be 0 to 0.300, alternatively 0 to 0.250, alternatively 0.100 to 0.240, and alternatively 0.102 to 0.240.

Subscript d may be 0, alternatively >0, alternatively at least 0.001, alternatively at least 0.002, alternatively at least 0.003, alternatively at least 0.004, alternatively at least 0.005, and alternatively at least 0.006; while at the same time, subscript d may be up to 0.020, alternatively up to 0.015, alternatively up to 0.010, alternatively up to 0.009, alternatively up to 0.008, alternatively up to 0.007, and alternatively up to 0.006. Alternatively, subscript d may be 0 to 0.020, alternatively >0 to 0.015, and alternatively 0.006 to 0.010.

Subscript e is >0.55 to 1. Alternatively, subscript e may be at least 0.550, alternatively at least 0.600, alternatively at least 0.650, alternatively at least 0.700, alternatively at least 0.750, alternatively at least 0.800; while at the same time, subscript e may be up to 1, alternatively up to 0.995, alternatively up to 0.991, alternatively up to 0.95, alternatively up to 0.925, alternatively up to 0.920, alternatively up to 0.915, alternatively up to 0.910, alternatively up to 0.905, and alternatively up to 0.0900. Alternatively, subscript e may be 0.905 to 1, alternatively 0.910 to 1, alternatively 0.915 to 1, alternatively 0.990 to 1, alternatively 0.991 to 1, alternatively 0.995 to 1, and alternatively subscript e may be 1.

In the unit formula above, each Z is an independently selected alkyl group. Suitable alkyl groups may be cyclic or acyclic, branched or unbranched, or a combination thereof. Alkyl groups are exemplified by, but not limited to, methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, tert-pentyl, and/or cyclopentyl), hexyl (e.g., cyclohexyl or n-hexyl), heptyl, octyl, nonyl, and decyl, as well as branched alkyl groups of 6 or more carbon atoms. Alternatively, each Z may be an alkyl group of 1 to 4 carbon atoms, alternatively 1 to 2 carbon atoms. Each Z may be methyl or ethyl; alternatively methyl.

The units (HO_{1/2}) and (ZO_{1/2}) represent hydroxyl and alkoxy groups, respectively, bonded to silicon atoms in resin (e.g., the hydroxyl and alkoxy groups are bonded to silicon atoms in the resinous portion of the alkoxy-functional silsesquioxane resin, which are portions of the molecule other than the grafted R² group of formula (I)). Without wishing to be bound by theory, it is thought that the hydroxyl and/or alkoxy groups may be bonded to any one or more of the silicon atoms in the monofunctional units of formula (R²₃SiO_{1/2}), the difunctional units of formula (R²₂SiO_{2/2}), and the trifunctional units of formula (R²SiO_{3/2}) in the alkoxy-functional silsesquioxane resin.

In the unit formula above, each alkyl group, R², is independently selected, and may be an alkyl group as described above for Z. Alternatively, each alkyl group for R² may be methyl. However, at least some groups R² have formula (I) (e.g., are the result of the hydrosilylation reaction in the method described below). In the unit formula, 5 mol % to 25 mol % of all R² groups may have formula (I) while the balance to 100 mol % of all R² groups are alkyl. Alternatively, at least 5 mol %, alternatively at least 6 mol %, alternatively at least 8 mol %, alternatively at least 9 mol %, alternatively at least 10 mol %, alternatively at least 13 mol %, alternatively at least 14 mol %, and alternatively at least 15 mol % of all R² groups have formula (I); while at the same time up to 25 mol %, alternatively up to 23 mol %, alternatively up to 20 mol %, alternatively up to 15 mol %, alternatively up to 14 mol %, alternatively up to 13 mol %, and alternatively up to 12 mol % of all R² groups have formula (I). Alternatively, the amount of R² groups with formula (I) may be 5 mol % to 25 mol %, alternatively 5 mol % to 23 mol %, alternatively 6 mol % to 15 mol %.

In the unit formula above, subscript f represents a molar amount of alkoxy groups in the resin, and subscript g represents a molar amount of hydroxyl groups in the resin. Subscripts f and g have values such that 0.01≤f≤0.70; 0≤g≤0.05; and 0.02≤(f+g)≤0.75. Alternatively, subscript f may have a value of at least 0.01, alternatively at least 0.10, alternatively at least 0.20, alternatively at least 0.30; while at the same time, subscript f may have a value up to 0.70, alternatively up to 0.60, alternatively up to 0.56, alternatively up to 0.52. Alternatively, subscript f may have a value such that 0.10≤f≤0.60, alternatively 0.30≤f≤0.60; alternatively 0.37≤f≤0.56; and alternatively 0.37≤f≤0.44. Alternatively, subscript g may have a value of at least 0.005, alternatively at least 0.008, alternatively at least 0.01; while at the same time, subscript g may have a value up to 0.05, alternatively up to 0.049, alternatively up to 0.045, alternatively up to 0.040, alternatively up to 0.035. Alternatively, subscript g may have a value such that 0.005≤g≤0.05, alternatively 0.006≤g≤0.049; alternatively 0.006≤g≤0.035; and alternatively 0.008≤g≤0.05. Alternatively, the quantity (f+g) may at least 0.02, alternatively at least 0.20, alternatively at least 0.30, alternatively at least 0.40, alternatively at least 0.41, alternatively at least 0.43, alternatively at least 0.45; while at the same time, the quantity (f+g) may be up to 0.57, alternatively up to 0.52, alternatively up to 0.49, alternatively up to 0.47, and alternatively up to 0.45. Alternatively, the quantity (f+g) may have a value such that 0.02≤(f+g)≤0.57; alternatively 0.20≤(f+g)≤0.57; alternatively 0.30≤(f+g)≤0.57; alternatively 0.40≤(f+g)≤0.57; alternatively 0.43≤(f+g)≤0.52; and alternatively 0.40≤(f+g)≤0.49.

In the group of formula (I) above, subscript a, b, and x each represent an integer. Subscript a is 1 or 2, alternatively, subscript a may be 1. Subscript b is 0 or 1. Alternatively, subscript b may be 0. Alternatively, subscript b may be 1. Subscript x is 0 or 1. Alternatively, subscript x may be 0.

In the group of formula (I) above, each alkyl group, R¹, is independently selected, and may be an alkyl group as described above for Z. Alternatively, each R¹ may be methyl.

In the group of formula (I) above, each D¹ is an independently selected alkylene group. D¹ may have empirical formula —CₕH₂ₕ—, where subscript h is at least 2, alternatively 2 to 12, alternatively 2 to 10, alternatively 2 to 8, alternatively 2 to 6, alternatively 2 to 4, and alternatively 2 to 3. Alternatively, each D¹ may be ethylene, propylene, or hexylene. Alternatively, each D¹ may be —C₂H₄—, such as ethylene.

The alkoxy-functional silsesquioxane resin may be, alternatively is, free of tetrafunctional siloxane units of formula (SiO_{4/2}). The alkoxy-functional silsesquioxane resin is in a liquid state at RT and ambient pressure (e.g., 101.325 kPa) (e.g., by visual inspection). Alternatively, the alkoxy-functional silsesquioxane resin may have Mn of 1,300 g/mol to 4,000 g/mol; alternatively 1,400 g/mol to 3,500 g/mol, and alternatively 2,000 g/mol to 2,500 g/mol. Alternatively, the alkoxy-functional silsesquioxane resin may have Mw of 1,000 g/mol to 50,000 g/mol; alternatively 2,000 g/mol to 50,000 g/mol; alternatively 2,500 g/mol to 40,000 g/mol; alternatively 4,000 to 10,000 g/mol; and alternatively 1,000 g/mol to 15,000 g/mol; and PDI of 2 to 4, alternatively 2.3 to 3.9.

The alkoxy-functional silsesquioxane resin described above may be prepared via a hydrosilylation reaction process. The process comprises: 1) combining, under conditions to effect hydrosilylation reaction, starting materials comprising: A) an alkoxy-functional organosilicon compound and B) a silsesquioxane resin in the presence of C) a hydrosilylation reaction catalyst. Starting material D), a solvent, may optionally be used to facilitate mixing and/or delivery of one or more of the starting materials. For example, C) the hydrosilylation reaction catalyst may be dissolved or dispersed in D) the solvent before combining with starting materials A) and B). Starting material A), the alkoxy-functional organosilicon compound, may comprise a silicon bonded hydrogen atom when B) the silsesquioxane resin comprises a silicon bonded aliphatically unsaturated group. Alternatively, A) the alkoxy-functional organosilicon compound may comprise an aliphatically unsaturated group when B) the silsesquioxane resin comprises a silicon bonded hydrogen atom.

Starting material C) is a hydrosilylation reaction catalyst. The hydrosilylation reaction catalyst comprises a platinum group metal. The platinum group metal may be selected from the group consisting of platinum, rhodium, ruthenium, palladium, osmium, and iridium. Alternatively, the platinum group metal may be platinum. The hydrosilylation reaction catalyst may be the platinum group metal or a compound or complex of the platinum group metal. For example, the hydrosilylation reaction catalyst may be a compound such as chloridotris(triphenylphosphane)rhodium(I) (Wilkinson's Catalyst), a rhodium diphosphine chelate such as [1,2-bis(diphenylphosphino)ethane]dichlorodirhodium or [1,2-bis(diethylphospino)ethane]dichlorodirhodium, chloroplatinic acid (Speier's Catalyst), chloroplatinic acid hexahydrate, platinum dichloride, or a complex of such a compound with an alkenyl-functional organopolysiloxane such as 1,3-diethenyl-1,1,3,3-tetramethyldisiloxane complexes with platinum (Karstedt's Catalyst) or Pt(0) complex in tetramethyltetravinylcyclotetrasiloxane (Ashby's Catalyst). Alternatively, the compound or complex may be microencapsulated in a matrix or coreshell type structure. Hydrosilylation reaction catalysts are known in the art, for example, as described in PCT Patent Application Publication WO2021/081822 to Guo, et al. and the references cited therein. Hydrosilylation reaction catalysts are commercially available, for example, SYL-OFF™ 4000 Catalyst and SYL-OFF™ 2700 are available from Dow. The amount of C) the hydrosilylation reaction catalyst depends on various factors including the types and amounts of starting materials A) and B), and their respective contents of silicon bonded hydrogen atoms and aliphatically unsaturated groups, however the amount of C) the hydrosilylation reaction catalyst is sufficient to catalyze the hydrosilylation reaction and may be, for example, an amount sufficient to provide at least 1 ppm of the platinum group metal based on combined weights of starting materials A), B), and C), while at the same time the amount may be sufficient to provide up to 6,000 ppm of the platinum group metal, on the same basis. Alternatively, the amount of starting material C) may be sufficient to provide 1 ppm to 1,000 ppm; alternatively 1 ppm to 100 ppm; alternatively 1 ppm to 50 ppm; alternatively 1 ppm to 25 ppm, and alternatively 1 ppm to 15 ppm, of the platinum group metal on the same basis.

Starting material D) is an optional solvent that may be used to deliver one or more of the starting materials. The solvent may be added facilitate introduction of certain starting materials, such as C) the hydrosilylation reaction catalyst. Solvents that can be used herein are those that help fluidize the starting materials, but essentially do not react with the starting materials. The solvent may be selected based on solubility the starting materials and volatility of the solvent. The solubility refers to the solvent being sufficient to dissolve and/or disperse a starting material. Volatility refers to vapor pressure of the solvent.

Suitable solvents include polyorganosiloxanes with suitable vapor pressures, such as hexamethyldisiloxane, octamethyltrisiloxane, hexamethylcyclotrisiloxane and other low polyorganosiloxanes, such as polydimethylsiloxanes, e.g., 0.5 to 1.5 cSt DOWSIL™ 200 Fluids and DOWSIL™ OS FLUIDS, which are commercially available from Dow.

Alternatively, the solvent may comprise an organic solvent. The organic solvent can be an alcohol such as methanol, ethanol, isopropanol, butanol, or n-propanol; an aromatic hydrocarbon such as benzene, toluene, ethylbenzene or xylene; an aliphatic hydrocarbon such as heptane, hexane, or octane; a halogenated hydrocarbon such as dichloromethane, 1,1,1-trichloroethane or methylene chloride; or a combination thereof.

The amount of D) the solvent will depend on various factors including the type of solvent selected and the amount and type of other starting materials selected for the composition. However, the amount of solvent may range from 1 weight % to 99 weight %, alternatively 2 weight % to 90 weight %, based on combined weights of starting materials A), B) and C).

The hydrosilylation reaction process may be performed by any convenient means, such as combining starting materials A), B), and C), and when present D). Typically, starting materials A) and B) are combined in a reactor. When the reaction is carried out at an elevated or reduced temperature as described below, the reactor may be heated or cooled in any suitable manner, e.g. via a jacket, mantle, exchanger, bath, or coils. Starting materials A), B), and C), and optionally D), may be fed together or separately to the reactor, or may be disposed in the reactor in any order of addition, and in any combination. For example, starting materials A) and C), and optionally D), may be added to a reactor, and starting material B) may be added thereto in one aliquot, alternatively starting material B) may be metered into the reactor continuously, or intermittently in two or more aliquots. Alternatively, starting materials B) and C), and optionally D), may be added to a reactor, and starting material A) may be added thereto in one aliquot, alternatively, starting material A) may be metered into the reactor continuously or intermittently in two or more aliquots. Order of addition may depend on various factors including which starting materials have silicon bonded hydrogen atoms.

Alternatively, starting materials A), B), and optionally D) may be first combined prior to the addition, or may be added to the vessel sequentially, and thereafter starting material C) may be added to the vessel containing starting materials A) and B), and optionally D). In general, reference to the “reaction mixture” herein refers generally to a mixture comprising starting materials A), B), and C), and optionally D), (e.g. as obtained by combining such starting materials, as described above).

The amounts of starting materials A) and B) are not restricted, and may be any amount sufficient to provide the content of groups of formula (I) in the alkoxy-functional silsesquioxane resin described above.

Step 1) of the process may further comprise agitating the reaction mixture. The agitating may enhance mixing and contacting together starting materials A), B), and C), and when present D), when combined, e.g. in the reaction mixture thereof. Such contacting independently may use other conditions, with (e.g. concurrently or sequentially) or without (i.e., independent from, alternatively in place of) the agitating. The other conditions may be tailored to enhance the contacting, and thus reactions (i.e., isomerization and hydrosilylation), of starting materials A) and B) to form the reaction product comprising the organosilicon compound.

Step 1) of the process may further comprise heating the reaction mixture. The temperature depends on various factors including the vapor pressures of starting materials A) and B), and when present D), however the temperature may be 50° C. to 150° C., alternatively 60° C. to 100° C.

The process described herein may optionally further comprise one or more additional steps. For example, the process may further comprise step 2): purifying the hydrosilylation reaction product, e.g., to remove and/or recover unreacted starting materials. Purifying may be performed by any convenient means such as stripping and/or distillation with heating and optionally under reduced pressure and/or azeotroping with solvents, filtration, and combinations thereof. The distillation conditions typically include: (i) an elevated temperature; (ii) a reduced pressure; or (iii) both an elevated temperature and reduced pressure. By elevated or reduced, it is meant as compared to room temperature and atmospheric pressure. The distillation may be continuous or batch, and may include use of a solvent (e.g. hexane, or toluene, or other solvent describe herein as starting material D)), such that the distillation may be an azeotropic distillation.

As used herein, purifying hydrosilylation reaction product is typically defined as increasing the relative concentration of the alkoxy-functional silsesquioxane resin as compared to other compounds in combination therewith (e.g. in the hydrosilylation reaction product or a purified version thereof). As is understood in the art, purifying may comprise removing the other compounds from such a combination (i.e., decreasing the amount of impurities and/or unreacted starting materials combined with the alkoxy-functional silsesquioxane resin in the hydrosilylation reaction product) and/or removing the alkoxy-functional silsesquioxane resin itself from the combination. Any suitable technique and/or protocol for purification may be used. Examples of suitable purification techniques include distilling, stripping, evaporating, extracting, filtering, washing, partitioning, phase separating, adsorption, and chromatography. As will be understood by those of skill in the art, any of these techniques may be used in combination (e.g., sequentially) with any another technique to purify the hydrosilylation reaction product. Regardless of the particular technique(s) selected, purifying the hydrosilylation reaction product may be performed in sequence (i.e., in line) with the hydrosilylation reaction itself, and thus may be automated. Alternatively, purifying may be a stand-alone procedure to which the hydrosilylation reaction product comprising the organosilicon compound is subjected.

For example, when A) the alkoxy-functional organosilicon compound has the silicon bonded hydrogen atom, and B) the silsesquioxane resin has the aliphatically unsaturated group, the process for preparing the alkoxy-functional silsesquioxane resin described above may comprise: 1) combining, under conditions to effect hydrosilylation reaction, starting materials comprising A1) an alkoxy-functional organohydrogensiloxane oligomer of formula:

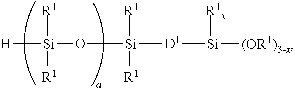

where R¹, D¹, a, and x are as described above; and B1) an alkenyl-functional silsesquioxane resin of unit formula (R³₃SiO_{1/2})_{c}(R³₂SiO_{2/2})_{d}(R³SiO_{3/2})ₑ(ZO_{1/2})_{f}(HO_{1/2})_{g}, where Z, c, d, e, f, and g are as described above and each R³ is independently selected from the group consisting of an alkyl group and an alkenyl group, with the proviso that at least one R³, per molecule, is an alkenyl group; in the presence of C) the hydrosilylation reaction catalyst described above; and optionally D) the solvent described above. The optional additional steps are as described above.

Starting material A1) is an alkoxy-functional organohydrogensiloxane oligomer of formula: A1) an alkoxy-functional organohydrogensiloxane oligomer of formula:

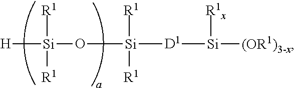

where R¹, D¹, a, and x are as described above. Alternatively, the alkoxy-functional organohydrogensiloxane oligomer may have subscript a=1, and subscript x=0. Alternatively, in the formula for A1) the alkoxy-functional organohydrogensiloxane oligomer, each R¹=methyl, each D¹ may have empirical formula —C₂H₄—. Alternatively, the alkoxy-functional organohydrogensiloxane oligomer may be trimethoxysilylethyl-1,1,3,3,5,5-hexamethyltrisiloxane; trimethoxysilylethyl-1,1,3,3-tetramethyldisiloxane; or a combination thereof. Alkoxy-functional organohydrogensiloxane oligomers of the formula shown above are known in the art and may be made by known methods, such as those described in U.S. Pat. No. 10,968,317 to Gohndrone, et al; U.S. Pat. No. 11,098,163 to Gohndrone, et al; U.S. Pat. No. 11,161,939 to Zhou, et al.; U.S. Pat. No. 11,168,181 to Zhou, et al.; and 11,492,448 to Gohndrone, et al; and JP2007077136 to Uehara, et al.

Starting material B1) is a silsesquioxane resin an alkenyl-functional silsesquioxane resin of unit formula (R³₃SiO_{1/2})_{c}(R³₂SiO_{2/2})_{d}(R³SiO_{3/2})ₑ(ZO_{1/2})_{f}; where Z, c, d, e, and f are as described above, and each R³ is independently selected from the group consisting of an alkyl group and an alkenyl group capable of undergoing hydrosilylation reaction, with the proviso that at least one R³, per molecule, is an alkenyl group. Examples of suitable alkenyl groups may have 2 to 12, alternatively 2 to 10, alternatively 2 to 8, and alternatively 2 to 6 carbon atoms. The alkenyl groups are capable of undergoing a hydrosilylation reaction with a silicon bonded hydrogen atom. Suitable alkenyl groups for R³ are exemplified by vinyl, allyl, and hexenyl; alternatively vinyl and hexenyl; and alternatively vinyl.

Starting material B1) can be prepared by known methods, such as co-hydrolyzing organosilanes having, per molecule, three hydrolyzable moieties, such as halogen or alkoxy, bonded to silicon atoms. For example, starting material B1) may be prepared by the process described in U.S. Pat. No. 11,248,119 by varying the starting materials and amounts thereof. Starting material B1) can be obtained, for example, by co-hydrolyzing methyltrimethoxysilane and vinyltrimethoxysilane, optionally with additional silanes such as octyltriethoxysilane and octyltrimethoxysilane. Alkoxysilanes with two alkoxy groups per molecule or 1 alkoxy group per molecule, such as dimethyldimethoxysilane or trimethylmethoxysilane may be included to add difunctional and/or monofunctional siloxane units to the silsesquioxane resin, respectively. An acid catalyst, such as triflic acid, water, and/or an alcohol may be used to facilitate co-hydrolysis.

Alternatively, when A) the alkoxy-functional organosilicon compound has the aliphatically unsaturated group and B) the silsesquioxane resin has the silicon bonded hydrogen atom, the process for preparing the alkoxy-functional silsesquioxane resin of described above may comprise: 1) combining, under conditions to effect hydrosilylation reaction, starting materials comprising A2) an alkoxy-functional organosilicon compound of formula R¹ₓR⁵Si(OR¹)₃₋ₓ, where R¹ and x are as described above, and R⁵ is an alkenyl group capable of undergoing hydrosilylation reaction; and B2) a hydrido-functional silsesquioxane resin of unit formula (R⁴₃SiO_{1/2})_{c}(R⁴₂SiO_{2/2})_{d}(R⁴SiO_{3/2})ₑ(ZO_{1/2})_{f}; where Z, c, d, e, and f are as described above and each R⁴ is independently selected from the group consisting of an alkyl group and H, with the proviso that at least one R⁴, per molecule, is H; in the presence of C) the hydrosilylation reaction catalyst, described above, and optionally D) the solvent, described above.

Starting material A2) is an alkoxy-functional organosilicon compound, which has at least one alkenyl group per molecule. The alkoxy-functional organosilicon compound may be an alkoxy-functional silane of formula R¹ₓR⁵Si(OR¹)₃₋ₓ, where R¹ and x are as described above, and R⁵ is an alkenyl group capable of undergoing hydrosilylation reaction. Examples of suitable alkenyl groups may have 2 to 12, alternatively 2 to 10, alternatively 2 to 8, and alternatively 2 to 6 carbon atoms. The alkenyl groups are capable of undergoing a hydrosilylation reaction with a silicon bonded hydrogen atom. Suitable alkenyl groups for R⁵ are exemplified by vinyl, allyl, and hexenyl; alternatively vinyl and hexenyl; and alternatively vinyl. Suitable alkoxy-functional silanes for starting material A2) are known in the art and are commercially available. For example, alkenyl-functional trialkoxysilanes such as allyltrimethoxysilane, vinyltrimethoxysilane, vinyltriethoxysilane, vinyltriisopropoxysilane, and vinyltris(methoxyethoxy)silane; alkenyl-functional dialkoxysilanes such as vinylphenyldiethoxysilane, vinylmethyldimethoxysilane, and vinylmethyldiethoxysilane; alkenyl-functional monoalkoxysilanes such as trivinylmethoxysilane are all available from Gelest, Inc. of Morrisville, Pennsylvania, USA.

Starting material B2) is hydrido-functional silsesquioxane resin of unit formula (R⁴₃SiO_{1/2})_{c}(R⁴₂SiO_{2/2})_{d}(R⁴SiO_{3/2})ₑ(ZO_{1/2})_{f}; where Z, c, d, e, and f are as described above and each R⁴ is independently selected from the group consisting of an alkyl group and H, with the proviso that at least one R⁴, per molecule, is H. Starting material B2) may be prepared by known methods, such as those described above for starting material B1) by substituting appropriate starting materials, such as hydrido-functional alkoxysilanes for alkenyl-functional alkoxysilanes. For example, starting material B2) may be prepared by the process described in U.S. Pat. No. 11,248,119 by varying the starting materials and amounts thereof.

The product of these processes is the alkoxy-functional silsesquioxane resin, described above. The alkoxy-functional silsesquioxane resin is useful in emulsions, e.g., for paint applications.

The non-aqueous phase of the emulsion comprises the alkoxy-functional silsesquioxane resin described above. The non-aqueous phase may contain the alkoxy-functional silsesquioxane resin in an amount of 50 to 100, alternatively 60 to 100, alternatively 70 to 100, alternatively 80 to 100, alternatively 90 to 100, alternatively 95 to 100, alternatively 96 to 100, alternatively 97 to 100, alternatively 98 to 100, alternatively 99 to 100, alternatively 100, weight percent based on the total weight of the non-aqueous phase.

The aqueous phase comprises water. The water may be from any source and may optionally be purified, e.g. through filtration, distillation, deionization, and/or reverse-osmosis techniques. The aqueous phase may comprise water, alternatively, alternatively consist of water. “Consist essentially of water”, as used herein means that the aqueous phase contains water, and optionally a surfactant and any optional additional starting materials described below. In particular, the aqueous phase may contain water in an amount of 50 to 100, alternatively 60 to 100, alternatively 70 to 100, alternatively 80 to 100, alternatively 90 to 100, alternatively 95 to 100, alternatively 96 to 100, alternatively 97 to 100, alternatively 98 to 100, alternatively 99 to 100, alternatively 100, weight percent based on the total weight of the aqueous phase.

The emulsion further comprises a surfactant. The surfactant may alternatively be referred to as an emulsifier and generally serves to emulsify the discontinuous phase in the continuous of the emulsion. The surfactant may be any surfactant suitable for preparing the emulsion with the non-aqueous phase and the aqueous phase.

For example, the surfactant may comprise one or more anionic, cationic, nonionic, and/or amphoteric surfactants, organomodified silicones such as dimethicone copolyol, oxyethylenated and/or oxypropylenated ethers of glycerol, oxyethylenated and/or oxypropylenated ethers of fatty alcohols such as ceteareth-30, C12-15 pareth-7, fatty acid esters of polyethylene glycol such as PEG-50 stearate, PEG-40 monostearate, saccharide esters and ethers such as sucrose stearate, sucrose cocoate and sorbitan stearate, and mixtures thereof, phosphoric esters and salts thereof such as DEA oleth-10 phosphate, sulphosuccinates such as disodium PEG-5 citrate lauryl sulphosuccinate and disodium ricinoleamido MEA sulphosuccinate, alkyl ether sulphates such as sodium lauryl ether sulphate, isethionates, betaine derivatives, and combinations thereof.

The anionic surfactants include (i) sulfonic acids and their salt derivatives, including alkyl or aralkyl (e.g., alkyl naphthalene or alkyl diphenyl ether) sulfonic acids, and their salts, having at least 6 carbon atoms in the alkyl substituent, such as dodecyl benzene sulfonic acid, and its sodium salt or its amine salt; (ii) alkyl sulfates having at least 6 carbon atoms in the alkyl substituent, such as sodium lauryl sulfate; (iii) the sulfate esters of polyoxyethylene monoalkyl ethers; (iv) long chain carboxylic acid surfactants, such as lauric acid, steric acid, oleic acid, and their alkali metal and amine salts. Some other examples of anionic surfactants are alkali metal sulfosuccinates; sulfonated glyceryl esters of fatty acids such as sulfonated monoglycerides of coconut oil acids; salts of sulfonated monovalent alcohol esters such as sodium oleyl isothionate; amides of amino sulfonic acids such as the sodium salt of oleyl methyl tauride; sulfonated products of fatty acid nitriles such as palmitonitrile sulfonate; sulfonated aromatic hydrocarbons such as sodium alpha-naphthalene monosulfonate; condensation products of naphthalene sulfonic acids with formaldehyde; sodium octahydro anthracene sulfonate; alkali metal alkyl sulfates; ether sulfates having alkyl groups of eight or more carbon atoms such as sodium lauryl ether sulfate; and alkylaryl sulfonates having one or more alkyl groups of eight or more carbon atoms such as neutral salts of hexadecylbenzene sulfonic acid and C₂₀ alkylbenzene sulfonic acid.

Commercial anionic surfactants which can be used include the sodium salt of dodecyl benzene sulfonic acid sold under the trademark SIPONATE™ DS-10 by Alcolac Inc. of Baltimore, Maryland, USA; sodium salt of alkyl alkoxylate sulfate sold under the trademark DOWFAX™ AS-801 by Dow; sodium n-hexadecyl diphenyloxide disulfonate sold under the trademark DOWFAX™ 8390 by Dow; the sodium salt of a secondary alkane sulfonate sold under the trademark HOSTAPUR™ SAS 60 by Clariant Corporation of Charlotte, North Carolina, USA; N-acyl taurates such as sodium N-lauroyl methyl taurate sold under the trademark NIKKOL LMT™ by Nikko Chemicals Company, Ltd. of Tokyo, Japan; and linear alkyl benzene sulfonic acids sold under the trademark BIO-SOFT™ S-100 by the Stepan Company of Northfield, Illinois, USA. Other suitable surfactants include sodium alkyl sulfonate such as HOSTAPUR™ SAS-30, and triethanolamine dodecyl benzene sulfonate, such as BIO-SOFT™ N 300.

Cationic surfactants useful herein include compounds containing quaternary ammonium hydrophilic moieties in the molecule which are positively charged, such as quaternary ammonium salts represented by R⁸R⁹R¹⁰R¹¹N⁺X″⁻ where R⁸ to R¹¹ are alkyl groups containing 1-30 carbon atoms, or alkyl groups derived from tallow, coconut oil, or soy; and X″ is a halogen, e.g., chlorine or bromine. Alternatively, the quaternary ammonium compounds may be alkyl trimethylammonium and dialkyldimethylammonium halides, or acetates, or hydroxides, having at least 8 carbon atoms in each alkyl substituent. Dialkyl dimethyl ammonium salts can be used and are represented by R¹²R¹³N⁺(CH₃)₂X″⁻ where R¹² and R¹³ are alkyl groups containing 12-30 carbon atoms or alkyl groups derived from tallow, coconut oil, or soy; and X″ is a halogen as described above. Monoalkyl trimethyl ammonium salts can be used and are represented by R¹⁴N+(CH₃)₃X′⁻ where R¹⁴ is an alkyl group containing 12-30 carbon atoms or an alkyl group derived from tallow, coconut oil, or soy; and X′ is halogen, acetate, or hydroxide.

Representative quaternary ammonium halide salts are dodecyltrimethyl ammonium chloride/lauryltrimethyl ammonium chloride (LTAC), cetyltrimethyl ammonium chloride (CTAC), didodecyldimethyl ammonium bromide, dihexadecyldimethyl ammonium chloride, dihexadecyldimethyl ammonium bromide, dioctadecyldimethyl ammonium chloride, dieicosyldimethyl ammonium chloride, and didocosyldimethyl ammonium chloride. These quaternary ammonium salts are commercially available under trademarks such as ADOGEN™ and VARIQUAT™ from Evonik of Essen, Germany, and ARQUAD™ from Nouryon.

Other suitable cationic surfactants which can be used include fatty acid amines and amides and their salts and derivatives, such as aliphatic fatty amines and their derivatives. AMMONYX™ by the Stepan Company.

Some suitable nonionic surfactants which can be used include polyoxyethylene alkyl ethers (such as, lauryl, cetyl, stearyl or octyl), polyoxyethylene alkyl phenol ethers, alkylglycosides, polyoxyethylene fatty acid esters, sorbitan fatty acid esters, polyoxyethylene sorbitan fatty acid esters, polyoxyethylene sorbitan monooleates, polyoxyethylene alkyl esters, polyoxyethylene sorbitan alkyl esters, polyethylene glycol (such as polyethylene glycol having 23 ethylene-oxide units), polypropylene glycol, diethylene glycol, ethoxylated trimethylnonanols, tristyrylphenol ethers (TSP's), distyryl phenol ethers (DSP's), and polyoxyalkylene glycol modified polysiloxane surfactants.

Nonionic surfactants, which are commercially available, include compositions such as (i) 2,6,8-trimethyl-4-nonyloxy polyethylene oxyethanols (6EO) and (10EO) sold under the names TERGITOL™ TMN-6 and TERGITOL™ TMN-10; (ii) the C₁₁₋₁₅ secondary alkyl polyoxyethylene ethers (e.g., C₁₁₋₁₅ secondary alcohol ethoxylates 7EO, 9EO, and 15EO sold under the names TERGITOL™ 15-S-7, TERGITOL™ 15-S-9, and TERGITOL™ 15-S-15, which has HL value 15.4), other C₁₁₋₁₅ secondary alcohol ethoxylates sold under the tradenames ECOSURF™ EH-40 and TERGITOL™ 15-S-12, TERGITOL™ 15-S-30, and TERGITOL™ 15-S-40, by Dow; octylphenyl polyoxyethylene (40) ether sold under the name TRITON™ X405 by Dow; (iii) nonylphenyl polyoxyethylene (10) ether sold under the name MAKON™ 10 by the Stepan Company; (iv) ethoxylated alcohols sold under the name Trycol 5953 by Henkel Corp./Emery Group of Cincinnati, Ohio, USA; (v) ethoxylated alcohols sold under the name BRIJ™ L23 (with HLB value of 16.9) and BRIJ™ L4 (with HLB value of 9.7) by Croda Inc. of Edison, New Jersey, USA, (vi) polyoxyethylene 23 lauryl ether (Laureth-23) sold commercially under the trademark BRIJ™ 23 by ICI Surfactants of Wilmington, Delaware, USA; and RENEX™ 30, a polyoxyethylene ether alcohol sold by ICI Surfactants; (vii) alkyl-oxo alcohol polyglycol ethers such as GENAPOL™ UD 050 (with HLB value of 11.4), and GENAPOL™ UD110 (with HLB value of 14.4), (viii) alkyl polyethylene glycol ether based on C₁₀-Guerbet alcohol and ethylene oxide such as LUTENSOL™ XP 79, and (ix) alkyl polyglycosides, such as those sold under the trade name Glucopon™ by BASF, and alkyl glucosides such as decyl glucoside, lauryl glucoside, and coco-glucoside, which are sold under the trade name EcoSense™ by Dow. Other commercially available nonionic surfactants include TERGITOL™ 15-S-5, also from Dow, which has an HLB value of 10.5; Lutensol XP 50 with an HLB value of 10, and Lutensol XP 140 with an HLB value of 16.

The nonionic surfactant may also be a silicone polyether (SPE). The SPE as a surfactant may have a rake type structure wherein the polyoxyethylene or polyoxyethylene-polyoxypropylene copolymeric units are grafted onto the siloxane backbone, or the SPE can have an ABA block copolymeric structure wherein A represents the polyether portion and B the siloxane portion of an ABA structure. Alternatively, the SPE may have a resinous structure, such as a polyorganosilicate resin having polyether groups bonded to silicon atoms therein. Suitable SPE's include DOWSIL™ OFX-5329 Fluid from Dow. Alternatively, the nonionic surfactant may be selected from polyoxyalkylene-substituted silicones, silicone alkanolamides, silicone esters and silicone glycosides. Such silicone-based surfactants may be used to form such aqueous emulsions and are known in the art, and have been described, for example, in U.S. Pat. No. 4,122,029 to Gee et al., U.S. Pat. No. 5,387,417 to Rentsch, and U.S. Pat. No. 5,811,487 to Schulz et al. Other silicone polyether surfactants are known in the art and are also commercially available, e.g., DOWSIL™ 502W and DOWSIL™ 67 Additive are commercially available from Dow.

Alternatively, the nonionic surfactant may comprise a polyvinyl alcohol compound. Polyvinyl alcohol compounds are known in the art and are disclosed, for example in U.S. Patent Application Publication 2007/0099007 at paragraphs and [0173]. Polyvinyl alcohol compounds may be made by saponification of polyvinylacetate, so up to 15% of polyvinylacetate may remain in the polyvinyl alcohol compound used herein. Alternatively, the polyvinyl alcohol compound may be 88% to 92% polyvinyl alcohol (with the balance being 12% to 8% polyvinylacetate). The polyvinyl alcohol compound may have a minimum viscosity of 5 cP at 4% aqueous solution at 20° C.

Examples of amphoteric surfactants include amino acid surfactants, betaines (e.g., lauryl betaine, bis-(2-hydroxyethyl) tallow betaine, cocamidopropylbetaine, N-alkylamidobetaines and derivatives thereof), proteins and derivatives thereof, glycinates (glycine derivatives, such as cocamphglycinate, cocamphocarboxy-glycinates, and cocamphodipropionate), sultaines (e.g., lauryl sultaine and cocamidopropylhydroxysultaine), alkyl aminopropionates, alkyl polyaminocarboxylates and alkylamphoacetates, lecithin and hydrogenated lecithin, and combinations thereof. These surfactants may also be obtained from other suppliers under different tradenames. For example, REWOTERIC™ AM TEG is produced by Evonik of Essen, Germany; AMPHOSOL™ CG is available from the Stepan Company.

The surfactant may be included in the emulsion at concentrations effective for emulsifying the non-aqueous phase in the aqueous phase (or vice versa). Such concentrations range from greater than 0 to 10 weight %, alternatively 0.3 weight % to 7.0, weight % based on the total weight of the emulsion. The surfactant, or combination of surfactants, may be present in the aqueous phase of the emulsion, the non-aqueous phase of the emulsion, an interface of the aqueous and non-aqueous phases, or combinations thereof.

One or more additional starting materials may optionally be combined with the emulsion. For example, the emulsion may further comprise a catalyst, e.g. a condensation reaction catalyst. The condensation reaction catalyst may be selected from any catalyst known in the art to effect condensation cure of condensation-curable compositions. The catalyst may be included in the emulsion just prior to any end use application thereof so as to prevent premature curing of components in the emulsion, e.g. as a two component (2k) system.

The condensation reaction catalyst used in the emulsion and/or the composition can be any chemical entity or molecule that may be used to promote a condensation reaction of silicon bonded hydroxy (silanol) groups and/or silicon bonded alkoxy groups to form Si—O—Si linkages (and by-product water and/or alcohol molecules) to give a condensation-cured product.

Examples of suitable condensation reaction catalysts include nitrogen-containing bases (e.g., nitrogen-containing superbases) described herein and complexes of lead, tin, titanium, zinc, and iron, such as various tin or titanium catalysts. Other examples include other basic compounds, such as trimethylbenzylammonium hydroxide, tetramethylammonium hydroxide and metal-containing compounds such as tetraethyl titanate, tetrapropyl titanate (e.g. tetraisopropyl orthotitanate), tetrabutyl titanate, titanium tetraisooctylate, titanium isopropylate tristearoylate, titanium triisopropylate stearoylate, titanium diisopropylate distearoylate, tetra(isopropoxy)titanium; tetra(n-butoxy)titanium and tetra(t-butoxy)titanium; organic titanium chelates such as di(isopropoxy)bis(ethylacetoacetate)titanium; di(isopropoxy)bis(methylacetoacetate)titanium; di(isopropoxy)bis(acetylacetonate)titanium; and bis(ethylacetoacetato-O1′, O3″)bis(propan-2-olato)titanium; zirconium tetrapropylate, zirconium tetraisopropylate, zirconium tetrabutylate, titanium acetylacetonate, aluminum triisobutoxide, aluminum triisopropoxide, zirconium tetra(acetylacetonato), zirconium tetrabutylate, cobalt octylate, cobalt acetylacetonato, iron acetylacetonato, tin acetylacetonato, dibutyltin octylate, dibutyltin laurate, zinc octylate, zinc benzoate, zinc p-tert-butylbenzoate, zinc laurate, zinc stearate, aluminum phosphate, and aluminum triisopropoxide; organic aluminum chelates such as aluminum trisacetylacetonate and aluminum bisethylacetoacetate monoacetylacetonate; and tin compounds such as dimethyltin dineodecanoate and stannous octoate.

Additional examples of condensation reaction catalysts include, but are not limited to aluminum alkoxides, antimony alkoxides, barium alkoxides, boron alkoxides, calcium alkoxides, cerium alkoxides, erbium alkoxides, gallium alkoxides, silicon alkoxides, germanium alkoxides, hafnium alkoxides, indium alkoxides, iron alkoxides, lanthanum alkoxides, magnesium alkoxides, neodymium alkoxides, samarium alkoxides, strontium alkoxides, tantalum alkoxides, titanium alkoxides, tin alkoxides, vanadium alkoxide oxides, yttrium alkoxides, zinc alkoxides, zirconium alkoxides, titanium or zirconium compounds, especially titanium and zirconium alkoxides, and chelates (such as alkyl acetylacetonate, ethanolamine, ammonium salts of lactic acid) and oligocondensates and polycondensates of the above alkoxides, dialkyltin diacetate, tin(II) octoate, dialkyltin diacylate, dialkyltin oxide and double metal alkoxides. Double metal alkoxides are alkoxides containing two different metals in a particular ratio. Condensation reaction catalysts are commercially available, for example, organic titanates and zirconates are available from Dorf Ketal under the tradename TYZOR™.

The amount of catalyst in the emulsion, if any, may vary and is not limiting. For example, the amount of catalyst may be a catalytically effective amount for promoting (enhancing) a hydrolysis and/or condensation reaction or curing of the alkoxy-functional silsesquioxane resin with itself and/or with another starting material used in the emulsion. However, the amount of catalyst included in the emulsion, if any, may be ≥0 to 1,000 ppm, alternatively 1 ppm to 500 ppm, alternatively 10 ppm to 100 ppm, alternatively 10 ppm to 50 ppm, alternatively 5 ppm to 30 ppm, and alternatively 5 ppm to 25 ppm, by weight of the emulsion. Alternatively, the amount of catalyst may be 0 to 10 weight %, alternatively >0 to 10 weight %, by weight of the emulsion.

The emulsion may further comprise one or more various optional starting materials (additives), such as coupling agents, antistatic agents (e.g., in an amount of 0 to 10 weight %, by weight of the emulsion), ultraviolet absorbers, plasticizers, leveling agents, preservatives, surface active materials (surfactants or detergents or emulsifiers), foam boosters, deposition agents, thickeners, water phase stabilizing agents, fillers, preservatives (e.g., in an amount of 0 to 1 weight %, by weight of the emulsion), suspending agents, biocides, freeze/thaw additives, anti-freeze agents, various thickeners, viscosity modifiers, foam control agents, dyestuff (e.g. pigment or other colorant), binders and combinations thereof. These optional additives and their amounts are exemplified by those disclosed in U.S. Pat. No. 11,248,119.

Alternatively or in addition to the above, the emulsion may further comprise various additive compounds for improving properties of the film formed therefrom. Examples of additive compounds are silanes, such as tetrakis(dimethylamine)silane, tetraethylorthosilicate, glycidoxypropyltrimethoxysilane, triethylsilane, and isobutyltrimethoxysilane; and siloxanes, such as 1,1,1,3,5,5,5-heptamethyltrisiloxane, and 1,1,3,3-tetramethyldisiloxane.

Alternatively, the emulsion may further comprise a dyestuff. The dyestuff may be selected from pulverulent dyestuffs (such as pigments and nacres) and water-soluble dyestuffs. The term “pigments” means white or colored, mineral or organic particles of any form, which are insoluble in the physiological medium, and which are intended to color the emulsion. The term “nacres” means iridescent particles of any form, produced especially by certain mollusks in their shell, or else synthesized.

The pigments may be white or colored, and mineral and/or organic. The mineral pigments include titanium dioxide, optionally surface-treated, zirconium oxide or cerium oxide, zinc oxide, iron oxide (black, yellow or red), chromium oxide, manganese violet, ultramarine blue, chromium hydrate, ferric blue, and metal powders, for instance aluminum powder or copper powder. The organic pigments include carbon black, pigments of D & C type, and lakes based on cochineal carmine or on barium, strontium, calcium or aluminum.

The pigment may also have an effect, such as particles comprising a natural or synthetic, organic or mineral substrate, for example glass, acrylic resins, polyester, polyurethane, polyethylene terephthalate, ceramics or aluminas, the substrate being uncoated or coated with metallic substances, for instance aluminum, gold, silver, platinum, copper or bronze, or with metal oxides, for instance titanium dioxide, iron oxide or chromium oxide, and combinations thereof.

The nacres may be chosen from white nacreous pigments such as mica coated with titanium or with bismuth oxychloride, colored nacreous pigments such as titanium mica coated with iron oxides, titanium mica coated with ferric blue or with chromium oxide, titanium mica coated with an organic pigment of the abovementioned type, and also nacreous pigments based on bismuth oxychloride. Interference pigments, such as liquid-crystal or multilayer interference pigments, may alternatively be used.

If present in the emulsion, the dyestuff may be included in any suitable amount contingent on desired end use properties of the emulsion. For example, in certain embodiments, the emulsion comprises the dyestuff in an amount of from 1 to 60, alternatively from 5 to 40, alternatively from 10 to 30, weight percent based on the total weight of the emulsion.

The filler suitable for use in the emulsion may be mineral or organic, of any form, platelet-shaped, spherical or oblong, irrespective of the crystallographic form (for example lamellar, cubic, hexagonal, or orthorhombic). Examples include talc, mica, silica, kaolin, polyamide, poly-β-alanine powder and polyethylene powder, tetrafluoroethylene polymer powders, starch, boron nitride, hollow polymer microspheres, acrylic acid copolymers, solid silicone resin microbeads, elastomeric polyorganosiloxane particles, precipitated calcium carbonate, magnesium carbonate, magnesium hydrogen carbonate, hydroxyapatite, hollow silica microspheres, glass and ceramic microcapsules, metal soaps such as zinc stearate, magnesium stearate, lithium stearate, zinc laurate, and magnesium myristate, and poly(methyl methacrylate) powders; and mixtures of two or more thereof. Alternatively, the filler may be a polyurethane powder. Fillers are commercially available. For example, SILLITIN V85 is available from Hoffman Mineral.

If present in the emulsion, the filler may be included in any suitable amount contingent on desired end use properties of the emulsion. For example, in certain embodiments, the emulsion comprises the filler in an amount of from 0 to 50 weight %, alternatively from 2.5 weight % to 40 weight %, alternatively from 5 weight % to 30 weight %, based on the total weight of the emulsion.

A thickener (also referred to as a viscosity modifier or a rheology modifier) may also be included in the emulsion, e.g., to achieve desired viscosity and flow properties. Thickeners such as cellulose derivatives including hydroxyethyl cellulose, methyl cellulose and carboxymethyl cellulose, or polyurethane thickeners may be utilized. The thickener is optional and it may be absent. Alternatively, the amount of thickener may be 0 to 10 weight %, alternatively >0 to 5 weight %, by weight of the emulsion. Thickeners are commercially available, such as ACRYSOL™ RM-2020E Rheology Modifier.

The emulsion may optionally further comprise a defoamer. The defoamer may be any suitable chemical additive that reduces and hinders the formation of foam in the emulsion or composition prepared therewith. Defoamers are known in the art and are typically selected based on other components present in the composition. Defoamers are commercially available. For example, DOWSIL™ 8590 Additive is available from Dow. The defoamer is optional, and it may be absent. Alternatively, the amount of defoamer may be 0 to 2 weight %, alternatively 0.5 weight % to 2 weight %, based on weight of the emulsion.

When the emulsion comprises the compatibilizer, the compatibilizer may be any compound or component which modifies, alternatively improves, the wetting of the components in the emulsion. Examples of such compatibilizers include titanium alcoholates, esters of phosphoric, phosphorous, phosphonic, and silicic acids, metallic salts and esters of aliphatic, aromatic, and cycloaliphatic acids, ethylene/acrylic or methacrylic acids, ethylene/esters of acrylic or methacrylic acid, ethylene/vinyl acetate resins, styrene/maleic anhydride resins or esters thereof, acrylonitrilebutadiene styrene resins, methacrylate/butadiene styrene resins (MBS), styrene acrylonitrile resins (SAN), and butadieneacrylonitrile copolymers. Alternatively or in addition, the compatibilizer may comprise a silane, e.g. a hydrocarbonoxysilane such as an alkoxysilane, a combination of an alkoxysilane and a hydroxy-functional polyorganosiloxane, an aminofunctional silane, or a combination thereof. The silane may include any functional group, which may be an adhesion-promoting group, such as amino, epoxy, mercapto and/or acrylate groups. Combinations of functional groups may be utilized, e.g. the compatibilizer may comprise an epoxy-functional alkoxysilane. Suitable epoxy-functional organic groups are exemplified by 3-glycidoxypropyl and (epoxycyclohexyl)ethyl. Unsaturated organic groups are exemplified by 3-methacryloyloxypropyl, 3-acryloyloxypropyl, and unsaturated monovalent hydrocarbon groups such as vinyl, allyl, hexenyl, undecylenyl. Examples of suitable epoxy-functional alkoxysilanes include 3-glycidoxypropyltrimethoxysilane, 3-glycidoxypropyltriethoxysilane, (epoxycyclohexyl)ethyldimethoxysilane, (epoxycyclohexyl)ethyldiethoxysilane and combinations thereof. Examples of suitable unsaturated alkoxysilanes include vinyltrimethoxysilane, allyltrimethoxysilane, allyltriethoxysilane, hexenyltrimethoxysilane, undecylenyltrimethoxysilane, 3-methacryloyloxypropyl trimethoxysilane, 3-methacryloyloxypropyl triethoxysilane, 3-acryloyloxypropyl trimethoxysilane, 3-acryloyloxypropyl triethoxysilane, and combinations thereof. Aminofunctional silanes, such as an aminofunctional alkoxysilanes, may have various amino groups, as understood in the art. Other examples of compatibilizers include modified polyethylene and modified polypropylene, which are obtained by modifying polyethylene and polypropylene, respectively, using a reactive group, including polar monomers such as maleic anhydride or esters, acrylic or methacrylic acid or esters, vinylacetate, acrylonitrile, and styrene.

Specific examples of UV stabilizers include phenol, 2-(2H-benzotriazol-2-yl)-6-dodecyl-4-methyl-, branched and linear (TINUVIN™ 571). Additional examples of suitable UV stabilizers include bis(1,2,2,6,6-pentamethyl-4-piperidyl) sebacate; methyl 1,2,2,6,6-pentamethyl-4-piperidyl/sebacate; and a combination thereof (TINUVIN™ 272). These and other TINUVIN™ additives, such as TINUVIN™ 765 are commercially available from Ciba Specialty Chemicals of Tarrytown, NY, U.S.A. Other UV and light stabilizers are commercially available, and are exemplified by LowLite from Chemtura, OnCap from PolyOne, and Light Stabilizer 210 from E. I. du Pont de Nemours and Company of Delaware, U.S.A. An example of an oligomeric antioxidant stabilizer (specifically, hindered amine light stabilizer (HALS)) is Ciba TINUVIN™ 622, which is a dimethylester of butanedioic acid copolymerized with 4-hydroxy-2,2,6,6-tetramethyl-1-piperidine ethanol.

If utilized, the antioxidant may be any antioxidant known in the art. Specific examples thereof include phenolic antioxidants and combinations of phenolic antioxidants with stabilizers. Phenolic antioxidants include fully sterically hindered phenols and partially hindered phenols; and sterically hindered amines such as tetramethyl-piperidine derivatives. Suitable phenolic antioxidants include vitamin E and IRGANOX™ 1010 from Ciba Specialty Chemicals, U.S.A. IRGANOX™ 1010 comprises pentaerythritol tetrakis(3-(3,5-di-t-butyl-4-hydroxyphenyl) propionate). Additional examples of antioxidants are as described in U.S. Pat. No. 11,248,119.

Biocides may be exemplified by fungicides, herbicides, pesticides, antimicrobial agents, or a combination thereof, and suitable examples are as described, for example, in U.S. Pat. No. 11,248,119.

Examples of suitable flame retardants are disclosed, for example, in U.S. Pat. No. 11,248,119 and include carbon black, hydrated aluminum hydroxide, and silicates such as wollastonite. Alternatively, the flame retardant, if utilized, may be selected from halogen based flame-retardants. Alternatively, the flame retardant, if utilized, may be selected from phosphorus based flame-retardants. Other suitable flame retardants may include tetraalkyl lead compounds, iron pentacarbonyl, manganese methyl cyclopentadienyl tricarbonyl, melamine and derivatives such as melamine salts, guanidine, dicyandiamide, ammonium sulphamate, alumina trihydrate, and magnesium hydroxide alumina trihydrate.

One skilled in the art would be able to select suitable additional starting materials for use in the emulsion, and would recognize that certain species of additional starting materials may have more than one function. For example, carbon black may be a filler, a pigment, and/or a flame retardant. The additional starting materials may be selected to be distinct from one another. The emulsion may comprise, for example, 50 weight % to 80 weight % of I) the alkoxy-functional silsesquioxane resin described above, >0 to 10 weight %, alternatively 2 weight % to 10 weight % of the surfactant, such the an anionic surfactant as described above, and 15 weight % to 40 weight % water, each based on combined weights of all starting materials in the emulsion. The alkoxy-functional silsesquioxane resin may be in the discontinuous phase, and the water may be in the continuous phase of this emulsion. Alternatively, the emulsion may be further defined as a composition, such as a paint composition, which further comprises one or more of the additional starting materials described above. For example, a paint composition may be prepared by combining one or more additional starting materials described above and the emulsion of the alkoxy-functional silsesquioxane resin, the surfactant, and water. For example, the paint composition may be prepared by combining the emulsion of the alkoxy-functional silsesquioxane resin, the surfactant, and water, wherein the emulsion may be in an amount of 30 weight % to 50 weight % of the paint composition, a dyestuff such as a pigment (e.g., in an amount of 40 weight % to 60 weight % of the paint composition), a defoamer (e.g., in an amount of 0.5 weight % to 2 weight % of the paint composition), and a filler (e.g., in an amount of 4.5 weight % to 10 weight % of the paint composition).

The emulsion may be prepared by a process comprising shearing or mixing the starting materials selected. Shearing or mixing can be accomplished by any method known in the art to effect mixing of high viscosity materials. The mixing may occur either as a batch, semi-continuous, or continuous process. Mixing may occur, for example using, batch mixing equipment with medium/low shear including change-can mixers, double-planetary mixers, conical-screw mixers, ribbon blenders, double-arm, and sigma-blade mixers; batch equipment with high-shear and high-speed dispersers including those made by Charles Ross & Sons (NY) and Hockmeyer Equipment Corp. (NJ); batch mixing equipment such as those sold under the tradename Speedmixer™; and batch equipment with high shear actions including Banbury-type (CW Brabender Instruments Inc., NJ) and Henschel type (Henschel mixers America, TX). Illustrative examples of continuous mixers/compounders include extruders, such as single-screw, twin-screw, and multi-screw extruders, co-rotating extruders such as those manufactured by Krupp Werner & Pfleiderer Corp (Ramsey, NJ) and Leistritz (NJ); twin-screw counter-rotating extruders, two-stage extruders, twin-rotor continuous mixers, dynamic and static mixers, and combinations of such equipment.

Combining the starting materials of the emulsion may occur in a single step or multiple step process. Thus, the starting materials may be combined in total, and subsequently mixed via any of the techniques described herein. Alternatively, only a portion(s) of the starting materials may first be combined and mixed, followed by combining additional quantities of any starting materials and further mixing. Typically, when forming the emulsion, the water is added in incremental portions, wherein sufficient incremental portions of water are added to form an emulsion. Further still, the emulsion (of the alkoxy-functional silsesquioxane resin, the surfactant and water) may be first prepared and subsequently combined with other starting materials or another composition or emulsion, e.g., the emulsion itself may be a component in another composition.

A method of preparing a film with the emulsion is provided. The method of preparing the film comprises applying the emulsion on a substrate. The method further comprises forming the film on the substrate.

The method by which the emulsion is applied on the substrate may vary. For example, the step of applying the emulsion on the substrate may use a wet coating application method. Specific examples of wet coating application methods suitable for the method include dip coating, spin coating, flow coating, spray coating, roll coating, gravure coating, sputtering, slot coating, inkjet printing, and combinations thereof.

The substrate is not limited and may be any material, and may be continuous or discontinuous and may have any size, shape, dimension, and surface roughness. In certain embodiments, the substrate comprises a plastic, which maybe a thermosetting and/or thermoplastic. However, the substrate may alternatively be glass, metal, paper, wood, a silicone, or other materials, or a combination thereof.

Specific examples of suitable plastic substrates include polyamides (PA); polyesters such as polyethylene terephthalates (PET), polybutylene terephthalates (PET), polytrimethylene terephthalates (PTT), polyethylene naphthalates (PEN), and liquid crystalline polyester; polyolefins such as polyethylenes (PE), polypropylenes (PP), and polybutylenes; styrenic resins; polyoxymethylenes (POM); polycarbonates (PC); polymethylenemethacrylates (PMMA); polyvinyl chlorides (PVC); polyphenylene sulfides (PPS); polyphenylene ethers (PPE); polyimides (PI); polyamideimides (PAI); polyetherimides (PEI); polysulfones (PSU); polyethersulfones; polyketones (PK); polyetherketones (PEK); polyvinyl alcohols (PVA); polyetheretherketones (PEEK); polyetherketoneketones (PEKK); polyarylates (PAR); polyethernitriles (PEN); phenolic resins; phenoxy resins; celluloses such as triacetylcellulose, diacetylcellulose, and cellophane fluorinated resins, such as polytetrafluoroethylenes; thermoplastic elastomers, such as polystyrene types, polyolefin types, polyurethane types, polyester types, polyamide types, polybutadiene types, polyisoprene types, and fluoro types; and copolymers and combinations thereof.

Typically, applying the emulsion on the substrate results in a wet film on the substrate, and forming the film on the substrate comprises drying the wet film on the substrate to form the film. For example, drying the wet film may comprise (i) evaporating water from the wet film; (ii) exposing the wet film to an elevated temperature to drive water therefrom; (iii) curing the wet film, or (iv) any combination of (i) to (iii). Forming the film from the wet film may also result in a chemical reaction beyond mere physical drying of the wet film. For example, alkoxy groups from the alkoxy-functional silsesquioxane resin, may react (e.g. cure) such that the film is the reaction product of the alkoxy-functional silsesquioxane resin and optionally one or more additional starting materials in the emulsion.

The film may be separable from the substrate (e.g. peelable) or may be physically and/or chemically bonded to the substrate. The substrate may have an integrated hot plate or an integrated or stand-alone furnace for drying/curing the deposit. The substrate may optionally have a continuous or non-continuous shape, size, dimension, surface roughness, and other characteristics. Alternatively, the substrate may have a softening point temperature at the elevated temperature. However, the emulsion and method are not so limited.

Typically, forming the film comprises exposing the wet film to an elevated temperature for a period of time. The elevated temperature is typically from 50° C. to 250° C., alternatively from 100° C. to 200° C., alternatively from 110° C. to 190° C., alternatively from 120° C. to 180° C., alternatively from 130° C. to 170° C., alternatively from 140° C. to 160° C., alternatively from 145° C. to 155° C. The period of time is typically sufficient to effect drying and/or curing, or at least curing (e.g. cross-linking) the alkoxy-functional silsesquioxane resin. The period of time may be >0 to 10, alternatively >0 to 5, alternatively >0 to 2, hours. The period of time may be broken down into dry/cure iterations, e.g. a first-cure and a post-cure, with the first-cure being, for example, one hour and the post-cure being, for example, one hour. The elevated temperature may be independently selected in such iterations, and may be the same in each iteration. Alternatively, the film may be formed by merely exposing the wet film to ambient conditions, i.e., drying at RT in the presence of atmospheric moisture and in the absence of any elevated temperature.

Depending on a thickness and other dimensions of the film, the film could also be formed via an iterative process. For example, a first deposit may be formed and optionally subjected to a first elevated temperature for a first period of time to give a partially dried and/or cured deposit. Then, a second deposit may be disposed on the first deposit or the partially dried and/or cured deposit and optionally subjected to a second elevated temperature for a second period of time to give a second partially dried/cured deposit. This process may be repeated, for example, from 1 to 50 times to build the film as desired. Each elevated temperature and period of time may be independently selected and may be the same as or different from one another. The iterative process may be wet-on-wet. Alternatively, the iterative process may be wet-on-dry, depending on a dry/cure state of the partially dried and/or cured deposit.

The film may have a thickness which varies depending upon its end use application. Typically, the film has a thickness of >0 to 4,000 μm, alternatively >0 to 3,000 μm, alternatively >0 to 2,000 μm, alternatively >0 to 1,000 μm, alternatively >0 to 500 μm, alternatively >0 to 250 μm, alternatively >0 to 100 μm, alternatively 1 to 50 μm, alternatively 20 to 30 μm. However, other thicknesses are contemplated, e.g. 0.1 to 200 μm. For example, the thickness of the film may be from 0.2 to 175 μm; alternatively from 0.5 to 150 μm; alternatively from 0.75 to 100 μm; alternatively from 1 to 75 μm; alternatively from 2 to 60 μm; alternatively from 3 to 50 μm; alternatively from 4 to 40 μm; alternatively any one of 1, 2, 3, 4, 5, 6, 7, 8, 9, 10, 15, 20, 25, 30, 35, 40, 45, 50, 60, 70, 75, 80, 90, 100, 150, 175, and 200 μm.

Independent of the method by which the film is formed, once the film is formed on the substrate from the emulsion and/or the composition, the film may further undergo post processing such as heating, humidification, catalytic post treatment, photoirradiation, or electron beam irradiation.

If desired, the film may be subjected to further processing depending upon its end use application. For example, the film may be subjected to oxide deposition (e.g. SiO₂ deposition), resist deposition and patterning, etching, chemical or plasma stripping, metallization, or metal deposition. Such further processing techniques are generally known. Such deposition may be chemical vapor deposition (including low-pressure chemical vapor deposition, plasma-enhanced chemical vapor deposition, and plasma-assisted chemical vapor deposition), physical vapor deposition, or other vacuum deposition techniques. Many such further processing techniques involve elevated temperatures, particularly vacuum deposition, for which the film is well suited in view of its excellent thermal stability. Depending on an end use of the film, however, the film may be utilized without such further processing.

### EXAMPLES

The following examples are provided to illustrate the invention to those skilled in the art and are not to be construed as limiting the scope of the invention set forth in the claims. The starting materials used in these examples are shown below in Table 1.

TABLE 1
Starting Materials

| Ingredient | | Chemical Description, | |
|---|---|---|---|
| Type | Product Name | Chemical formula, or Structure | Source |
| Pt catalyst | Karstedt's catalyst | platinum vinylmethylsiloxane | Dow |
| | | complex | |
| Catalyst | FC24; Triflic acid | Trifluoromethanesulfonic acid | Sigma |
| | | of formula (F₃C)S(═O)₂OH | Aldrich |
| Catalyst | potassium hydroxide | KOH | Fisher |
| | | | Scientific |
| Silane Reactant | methyltrimethoxysilane | MeSi(OMe)₃ | Acros |
| | | | Organics |
| Silane Reactant | vinyltrimethoxysilane | ViSi(OMe)₃ | TCI |
| Reactant | hexamethyldisiloxane | Me₃SiOSiMe₃ | Dow |
| Silane Reactant | octyltriethoxysilane | OctSi(OEt)₃ | Dow |
| Silane Reactant | dimethyldimethoxysilane | Me₂Si(OMe)2 | Dow |
| Silane Reactant | 1,1,3,3-tetramethyldisiloxane | HMe₂SiOSiMe₂H | Alfa Aesar |
| Silane Reactant | octamethylcyclotetrasiloxane | D4 cyclics | Dow |
| Reactant | ETM converter | trimethoxysilylethyl-1,1,3,3- | Dow |
| | | tetramethyldisiloxane | |
| Silane Reactant | methyldimethoxysilane | MeHSi(OMe)₂ | Dow |
| Solvent | toluene | C₇H₈ | Fisher |
| | | | Scientific |
| Solvent | n-heptane | C₇H₁₆ | Fisher |
| | | | Scientific |
| Reactant | DI water | H₂O | Building |
| | | | Supply |
| Neutralizing | calcium carbonate | CaCO₃ | ? |
| agent | | | |
| Neutralizing | acetic acid | C₂H₄O₂ | Fisher |
| agent | | | Scientific |
| Moisture Cure | Bis(ethylacetoacetato-01′, 03″) | TYZOR ™ PITA-SM | Dorf Ketal |
| Package | bis(propan-2-olato) titanium and | | |
| | methyltrimethoxysilane | | |
| Comparative | Solventless liquid methyl siloxane | DOWSIL ™ 2405 Resin | Dow |
| Resin | (no phenyl) resin, methoxy- | | |
| | functional, with 28 weight % | | |
| | methoxy content, 72 weight % | | |
| | silicone resin content | | |
| Comparative | Solventless liquid methyl siloxane | DOWSIL ™ US-CF-2403 Resin | Dow |
| Resin | (no phenyl) resin, methoxy- | | |
| | functional with molecular | | |
| | weight <1000 | | |
| Anionic | Sodium Lauryl Sulfate | STEPANOL ™ WA-Extra | Stepan |
| Surfactant | | | Company |
| Pigment | | Liquid black HS16303 | Lanxess |
| Dispersion | | | |
| Defoamer | Silicone antifoam compound with | DOWSIL ™ 8590 Additive | Dow |
| | silica | | |
| Filler | Silica kaolinite mixture | SILLITIN V85 | Hoffman |
| | | | Mineral |
| Condensation | | TYZOR ™ TAA | Dorf Ketal |
| Catalyst | | | |
| Thickener | | ACRYSOL ™ RM-2020 | |

In this Reference Example 1, samples of vinyl-functional silsesquioxane resins were made as follows: A 1000 mL 3 neck flask was equipped with a magnetic stir bar, water-cooled condenser, thermocouple, and a nitrogen blanket. The following starting materials were loaded into the flask: 1) the methoxysilanes in amounts shown below in Table 2, and then triflic acid in the amount shown below in Table 2 was added. DI water in the amount shown below in Table 2 was added to the flask slowly, starting at RT. An exotherm was observed to 64° C. The flask contents were then heated at 65° C. for 2 h. A Dean Stark apparatus was used to distill off some methanol. The flask contents were cooled to 50° C., and CaCO₃ was added to neutralize the triflic acid. The flask contents were mixed overnight at RT. The resulting product was stripped on a rotary evaporator heated with an oil bath at a temperature of 80° C. under reduced pressure of 4 mmHg. The flask contents were then cooled to RT and pressure filtered through a 47 mm diameter Magna, Nylon, Supported, Plain 0.45 μm filter. A vinyl-functional silsesquioxane resin was produced.

In this Reference Example 2, samples of vinyl-functional MDT resins were prepared as described above in Reference Example 1, except octyltriethoxysilane and tetramethyldisiloxane were added. Samples CE2 and CE4 were prepared by this method. These samples are summarized below in Table 3.

In this Reference Example 3, samples of hydrido-functional silsesquioxane resins were made as follows: A 1L 3 neck flask was equipped with a thermocouple, Teflon stir paddle attached to a glass stir rod, Dean Stark apparatus attached to a water-cooled condenser, and a nitrogen blanket. The following starting materials were loaded into the flask: the methoxysilane in the amount shown below in Table 2, and then triflic acid in the amount shown below in Table 2 was added. DI water in the amount shown below in Table 2 was added to the flask slowly, starting at RT. An exotherm was observed to 58° C. The flask contents were then heated at 65° C. for 30 min. The Dean Stark apparatus was used to distill off some methanol.

Tetramethyldisiloxane was added to the flask, and then DI water was added to the flask, in the amounts shown below in Table 4. The flask contents were heated at 55° C. for 3 h. Methanol was then distilled out at a temperature in the flask of 70° C. The amount removed was 77 g. CaCO₃ was added to neutralize the triflic acid. The flask contents were mixed overnight at RT. The resulting product was stripped under reduced pressure of 3 mmHg using a rotary evaporator heated with an oil bath at a temperature of 80° C. The flask contents were then cooled to RT and pressure filtered through a 47 mm diameter Magna, Nylon, Supported, Plain 0.45 μm filter. A vinyl-functional silsesquioxane resin was produced. CE5 and CE6 were prepared using this process. CE6 used a different ratio of starting materials than CE5. These samples are summarized below in Table 4.

In this Reference Example 4, samples of octyl-functional DT resins were made as follows: The same apparatus was used as in Reference Example 1. Methyltrimethoxysilane (355 g), octyltriethoxysilane (41 g), and D4 cyclics (18 g) were added to the flask. Triflic acid (0.21 g) was then added, and DI water (71 g) was then added slowly starting at RT. An exotherm to 64° C. was observed, and the flask contents were then heated at 65° C. for 2 h. Some alcohol (methanol and ethanol) was distilled off using the Dean stark apparatus. The amount removed was 213 g. Next, n-heptane (144 g) was added, and then calcium carbonate (0.83 g) was added to neutralize the triflic acid. The flask contents were mixed for 1 h while cooling. Volatiles were distilled off up to a vapor temperature of 98° C. The amount removed was 91 g. the resulting product was filtered through a 47 mm diameter Magna, Nylon, Supported, Plain 0.45 μm filter. The resulting resin was stripped at 1-2 mmHg using a rotary evaporator heated with an oil bath at a temperature of 80° C. CE8 and CE9 were prepared using this process. These samples are summarized below in Table 4.

TABLE 2
Starting Materials Used in Comparative
Examples (amounts in grams)

| Starting | Example | | |
|---|---|---|---|
| Material | CE1 | CE3 | CE7 |
| MeSi(OMe)₃ | 355 | 354.9 | 354.9 |
| ViSi(OMe)₃ | 68 | 68.0 | 68.0 |
| Triflic acid | 0.21 | 0.21 | 0.21 |
| DI water | 68 | 71.8 | 71.8 |
| methanol removed | 190 | 204.0 | 207.1 |
| CaCO₃ | 0.84 | 0.84 | 0.84 |
| Heptane | 0 | 59.9 | 90.0 |
| Unit Formula of | T^{Me}_{0.843}T^{Vi}_{0.148} | T^{Me}_{0.856}T^{Vi}_{0.144} | T^{Me}_{0.853}T^{Vi}_{0.147} |
| Resin Produced | | | |
| Preparation Method | Reference | Reference | Reference |
| | Example 1 | Example 1 | Example 1 |

TABLE 3
Starting Materials Used in Comparative Examples (amounts in grams)

| Starting | Example | |
|---|---|---|
| Material | CE2 | CE4 |
| MeSi(OMe)₃ | 294.2 | 294.2 |
| ViSi(OMe)₃ | 66.7 | 66.7 |
| OctSi(OEt)₃ | 35.2 | 41.2 |
| D4 Cyclics | 17.8 | 17.8 |
| Triflic acid | 0.21 | 0.21 |
| DI water | 59.7 | 65.1 |
| Alcohol removed | 170.6 | 196.8 |
| CaCO₃ | 0.83 | 0.84 |
| Heptane | 0 | 156.0 |
| Unit Formula of | D^{Me2}_{0.088}T^{Me}_{0.728}T^{Octyl}_{0.040}T^{Vi}_{0.144} | D^{Me2}_{0.078}T^{Me}_{0.732}T^{Octyl}_{0.050}T^{Vi}_{0.140} |
| Resin Produced | | |
| Preparation Method | Reference Example 2 | Reference Example 2 |

TABLE 4
Starting Materials Used in Comparative Examples (amounts in grams)

| Starting | Example | | | |
|---|---|---|---|---|
| Material | CE5 | CE6 | CE8 | CE9 |
| MeSi(OMe)₃ | 355 | 354.9 | 356 | 356 |
| OctSi(OEt)₃ | 0 | 0 | 41 | 41 |
| D4 | 0 | 0 | 18 | 18 |
| Triflic acid | 0.18 | 0.18 | 0.21 | 0.21 |
| HMe₂SiOSiMe₂H | 31 | 43.7 | 0 | 0 |
| DI water | 55 + 4.1 | 55.2 + 4.1 | 71 | 71 |
| Alcohol removed | 118 + 77 | 115.1 + 82.9 | 213 | 213 |
| n-heptane | 0 | 0 | 144 | 144 |
| CaCO₃ | 0.71 | 0.71 | 0.83 | 0.83 |
| Unit Formula of | M^{H}_{0.102}T^{Me}_{0.892} | M^{H}_{0.137}T^{Me}_{0.855} | D^{Me2}_{0.08}T^{Me}_{0.87}T^{Oct}_{0.05} | D^{Me2}_{0.08}T^{Me}_{0.87}T^{Oct}_{0.05} |
| Resin Produced | | | | |
| Preparation | Reference | Reference | Reference Example 4 | Reference Example 4 |
| Method | Example 3 | Example 3 | | |

In this Reference Example 5, ETM-converted DT resins were prepared as follows: A 250 mL flask was equipped with a thermocouple, magnetic stir bar, and a water-cooled condenser. A vinyl functional resin with unit formula D^{Me2}_{0.009} T^{Me}_{0.843} T^{Vi}_{0.148} from Comparative Example 3 (50 g), ETM converter (26 g), and toluene (76 g) were loaded into the flask. A nitrogen blanket was applied. The flask contents were heated to 70° C., and Karstedt's catalyst (amount sufficient to provide 10 ppm Pt based on combined weights of the resin and ETM) was added. The flask contents were heated at 100° C. for 21 h. FTIR was used to monitor SiH content as indicator of reaction product. The resulting product was stripped to dryness at 0.5-1 mmHg using a rotary evaporator heated by an oil bath at a temperature of 80° C. Samples IE2, IE3, and IE5 were made by this procedure, by varying the amounts of starting materials. These samples are summarized below in Table 5. The amounts are in grams, unless otherwise indicated, in Table 5, below.

In this Reference Example 6, ETM-converted DT resins were prepared according to the method of Reference Example 5, except the resin of CE2 was used as the vinyl functional resin starting material for sample IE4, and the resin of CE4 was used as the vinyl functional resin starting material for sample IE6. These samples are summarized below in Table 6. The amounts are in grams, unless otherwise indicated, in Table 6, below.

In this Reference Example 7, samples IE7 and IE8 were prepared as follows: A 500 mL 3neck flask was equipped with a thermocouple, magnetic stir bar, and a water-cooled condenser. The flask was loaded with the resin of formula M^{H}_{0.102}T^{Me}_{0.892} Resin (sample CE5) or M^{H}_{0.102} T^{Me}_{0.892} Resin (sample CE6) and heptane. A nitrogen blanket was applied. The contents of the flask were heated to 80° C. Karstedt's Pt catalyst was added in an amount to equal 5 ppm Pt based on resin. Vinyltrimethoxysilane was added slowly with an addition funnel. Exotherm to 94° C. The contents of the flask were heated at ~100° C. for 3 h. FTIR was used to verify the reaction was complete. The product was stripped dryness at 1-2 mmHg using a rotary evaporator heated with an oil bath at a temperature of 80° C. These samples are summarized below in Table 7. The amounts are in grams, unless otherwise indicated, in Table 7, below.

In this Reference Example 8, sample IE9 was prepared as follows: A 500 mL 3 neck flask was equipped with a thermocouple, magnetic stir bar, and a water-cooled condenser. Into the flask were loaded T^{Me}_{0.853}T^{Vi}_{0.147} Resin (150 g) prepared as described above, sample CE7, and heptane (81 g). A nitrogen blanket was applied. The flask contents were heated to 50° C., and then Karstedt's Pt catalyst was added in an amount to result in 5 ppm Pt based on resin+MeHSi(OMe)₂. MeHSi(OMe)₂ (30 g) was added to the flask slowly using an addition funnel. The flask contents were heated at 60° C. for a total of 23 h. At the 5 h mark, additional Karstedt's Pt Catalyst was added sufficient to increase Pt concentration to 10 ppm, and then at the 22 h mark additional Karstedt's Pt catalyst was added sufficient to increase the Pt concentration to 15 ppm. The progress of the reaction was monitored reaction by FTIR. The resulting product was stripped to dryness at 1-2 mmHg using a rotary evaporator heated with an oil bath at a temperature of 80° C. This sample is summarized below in Table 8.

TABLE 5
Starting Materials for Working Examples (amounts in grams unless otherwise indicated)

| Starting | Example | | |
|---|---|---|---|
| Material | IE2 | IE3 | IE5 |
| D^{Me2}_{0.009}T^{Me}_{0.843}T^{Vi}_{0.148} | 50 | 50 | 0 |
| T^{Me}_{0.856}T^{Vi}_{0.144} | 0 | 0 | 110 |
| ETM converter | 26 | 26 | 56.5 |
| Toluene | 76 | 76 | 111.0 |
| Karstedt's catalyst | Amount sufficient to | Amount sufficient to | Amount |
| | provide 10 ppm Pt | provide 10 ppm Pt | sufficient to |
| | based on weights of | based on weights of | provide 15 ppm |
| | reactants | reactants | Pt based on |
| | | | weights of |
| | | | reactants |
| Unit Formula of Resin | D^{Me2}_{0.009}T^{Me}_{0.843}T^{ETM}_{0.148} | D^{Me2}_{0.009}T^{Me}_{0.843}T^{ETM}_{0.148} | T^{Me}_{0.856}T^{ETM}_{0.144} |
| Produced | | | |
| Preparation Method | Reference Example 5 | Reference Example 5 | Reference |
| | | | Example 5, |
| | | | except the resin |
| | | | of CE3 was |
| | | | used as the |
| | | | starting |
| | | | material instead |
| | | | of CE1 |

TABLE 6
Starting Materials for Working Examples IE4 and IE6

| Starting | Example | |
|---|---|---|
| Material | IE4 | IE6 |
| D^{Me2}_{0.088}T^{Me}_{0.728}T^{Oct}_{0.040}T^{Vi}_{0.144} | 50 | 50 |
| ETM converter | 26 | 26 |
| Toluene | 76 | 76 |
| Karstedt's catalyst | Amount sufficient to provide 10 | Amount sufficient to provide 10 |
| | ppm Pt based on weights of | ppm Pt based on weights of |
| | reactants | reactants |
| Unit Formula of Resin | D^{Me2}_{0.088}T^{Me}_{0.728}T^{Oct}_{0.040}T^{ETM}_{0.144} | D^{Me2}_{0.078}T^{Me}_{0.732}T^{Oct}_{0.050}T^{ETM}_{0.140} |
| Produced | | |
| Preparation Method | Reference Example 6 | Reference Example 6 |

TABLE 7
Starting Materials for Working Examples IE7 and IE8

| Starting | Example | |
|---|---|---|
| Material | IE7 | IE8 |
| Resin | 140 | 140 |
| Heptane | 114 | 114 |
| Vinyltrimeth- | 30 | 30 |
| oxysilane | | |
| Toluene | 76 | 76 |
| Karstedt's catalyst | Amount sufficient to | Amount sufficient to |
| | provide 5 ppm Pt based | provide 5 ppm Pt based |
| | on weight of the resin | on weight of the resin |
| Unit Formula of | M^{TM}_{0.102}T^{Me}_{0.892} | M^{TM}_{0.137}T^{Me}_{0.855} |
| Resin Produced | | |
| Preparation Method | Reference Example 7 | Reference Example 7 |

Note: The resin of CE5 was used to prepare IE7, and the resin of CE6 was used to prepare IE8.

TABLE 8
Starting Materials for Working Examples IE9

| Starting | Example |
|---|---|
| Material | IE9 |
| T^{Me}_{0.853}T^{Vi}_{0.147} Resin | 150 |
| Heptane | 81 |
| MeHSi(OMe)₂ | 30 |
| Karstedt's catalyst | 15 ppm based on weight of reactants |
| Unit Formula of Resin Produced | T^{Me}_{0.853}T^{DM}_{0.147} |
| Preparation Method | Reference Example 8 |

TABLE 9
Properties of Resins Prepared as Described Above

| Resin | | | |
|---|---|---|---|
| Synth- | | | Physical |
| esis | | FW | State of |
| Exam- | Composition | (g/mol | solventless |
| ples | (Si molar ratios) | Si) | resin |
| CE | D^{Me2}_{0.15}T^{Me}_{0.83}T^{Oct}_{0.02} | Not de- | Low viscosity |
| | | termined | liquid |
| CE1 | D^{Me2}_{0.009}T^{Me}_{0.843}T^{Vi}_{0.148} | 81.9 | low viscosity |
| | | | liquid |
| CE2 | D^{Me2}_{0.088}T^{Me}_{0.728}T^{Oct}_{0.040}T^{Vi}_{0.144} | 85.8 | low viscosity |
| | | | liquid |
| CE3 | T^{Me}_{0.856}T^{Vi}_{0.144} | 79.2 | viscous liquid |
| CE4 | D^{Me2}_{0.078}T^{Me}_{0.732}T^{Oct}_{0.050}T^{Vi}_{0.140} | 84.4 | viscous liquid |
| CE5 | M^{H}_{0.102}D^{Me2}_{0.006}T^{Me}_{0.892} | 76.4 | viscous liquid |
| CE6 | M^{H}_{0.137}D^{Me2}_{0.008}T^{Me}_{0.855} | 75.9 | viscous liquid |
| CE7 | T^{Me}_{0.853}T^{Vi}_{0.147} | 79.3 | viscous liquid |
| CE8 | D^{Me2}_{0.08}T^{Me}_{0.87}T^{Oct}_{0.05} | 79.5 | high viscosity |
| | | | liquid |
| CE9 | D^{Me2}_{0.08}T^{Me}_{0.87}T^{Oct}_{0.05} | 78.8 | very high |
| | | | viscosity liquid |

| Resin | | | | OR | | grafted |
|---|---|---|---|---|---|---|
| Synthesis | | | | (OMe + OEt | OH | OMe |
| Examples | Mn | Mw | PD | mol %) | (mol %) | (mol %) |
| CE | 2,638 | 10,854 | 4.11 | 49.3 | ~2.1 | 0 |
| CE1 | 1,486 | 3,206 | 2.16 | 55.7 | 1.2 | 0 |
| CE2 | 1,374 | 2,584 | 1.88 | Not | 1.0 | 0 |
| | | | | determined | | |
| CE3 | 1,824 | 5,108 | 2.80 | 43.55 | 3.51 | 0 |
| CE4 | 1,697 | 4,111 | 2.42 | ~40.4 | ~3.1 | 0 |
| CE5 | 2,250 | 4,785 | 2.13 | 39.65 | 0.76 | 0 |
| CE6 | 1,820 | 3,396 | 1.87 | 37.37 | 1.64 | 0 |
| CE7 | 1,715 | 4,415 | 2.58 | 43.35 | 4.94 | 0 |
| CE8 | 3,017 | 26,152 | 8.67 | 25.3 | 8.2 | 0 |
| CE9 | 3,624 | 47,861 | 13.21 | 22.1 | 6.1 | 0 |

| Resin | | | |
|---|---|---|---|
| Synth- | | | Physical |
| esis | | FW | State of |
| Exam- | Composition | (g/mol | solventless |
| ples | (Si molar ratios) | Si) | resin |
| IE1 | M_{0.24}D^{Me2}_{0.01}T^{Me}_{0.69}T^{ETM}_{0.06} | | viscous liquid |
| IE2 | D^{Me2}_{0.009}T^{Me}_{0.843}T^{ETM}_{0.148} | | low viscosity |
| | | | liquid |
| IE3 | D^{Me2}_{0.009}T^{Me}_{0.843}T^{ETM}_{0.148} | | low viscosity |
| | | | liquid |
| IE4 | D^{Me2}_{0.088}T^{Me}_{0.728}T^{Oct}_{0.040}T^{ETM}_{0.144} | | low viscosity |
| | | | liquid |
| IE5 | T^{Me}_{0.856}T^{ETM}_{0.144} | | viscous liquid |
| IE6 | D^{Me2}_{0.078}T^{Me}_{0.732}T^{Oct}_{0.050}T^{ETM}_{0.140} | | viscous liquid |
| IE7 | M^{TM}_{0.102}D^{Me2}_{0.006}T^{Me}_{0.892} | | viscous liquid |
| IE8 | M^{TM}_{0.137}D^{Me2}_{0.008}T^{Me}_{0.855} | | liquid |
| IE9 | T^{Me}_{0.853}T^{DM}_{0.147} | | viscous liquid |

| Resin | | | | OR | | grafted |
|---|---|---|---|---|---|---|
| Synthesis | | | | (OMe + OEt | OH | OMe |
| Examples | Mn | Mw | PD | mol %) | (mol %) | (mol %) |
| IE1 | n/a | n/a | n/a | 1.60 | 0.64 | 18.9 |
| IE2 | n/a | n/a | n/a | 55.7 | 1.2 | 44.4 |
| IE3 | n/a | n/a | n/a | 55.7 | 1.2 | 44.4 |
| IE4 | n/a | n/a | n/a | 51.3 | 1.0 | 43.2 |
| IE5 | n/a | n/a | n/a | 43.6 | 3.5 | 43.2 |
| IE6 | n/a | n/a | n/a | ~40.4 | ~3.1 | 42.0 |
| IE7 | 2,099 | 4,831 | 2.30 | 39.7 | 0.8 | 30.6 |
| IE8 | n/a | n/a | n/a | 37.4 | 1.6 | 41.1 |
| IE9 | 2,354 | 9,014 | 3.83 | 43.4 | 4.9 | 29.4 |

In this Reference Example 9, some of the resins prepared as described above were formulated into emulsion compositions. Each sample was prepared by combining 66.6 weight parts of the resin and 6.66 weight parts of Anionic Surfactant by blending with a dental mixer for 30 sec at 3600 rpm. Water in an amount of 26.74 weight parts was added to generate an emulsion.

In this Reference Example 10 each emulsion prepared as described in Reference Example 9 was tested as a binder in a paint composition by combining the emulsion with a pigmented paste, followed by 1 min of mixing at 2000 rpm using a Speedmixer, and 24 h in can stabilization and remixing before application. The pigmented paste composition contained the starting materials in amounts shown below in Table 10.

TABLE 10

| Starting Material | Weight Parts |
|---|---|
| Pigment Dispersion | 86.7 |
| Defoamer | 2.4 |
| Filler | 10.9 |

The pigmented paste composition was prepared as follows: Using a blade, the defoamer was added to the pigment dispersion and stirred for 10 min. To this blend, the filler was added and stirred once again for 10 min. The resulting pigmented paste had a NVC of 72.57%

The paint composition was obtained by blending 60% of the previous pigmented paste and 40% of the emulsion prepared as described in Reference Example 9. Once done the Condensation Catalyst (TYZOR™ TAA from Dorf Ketal) was added. The samples paint compositions were each applied by drawdown (wet film thickness=150 μm) on a CRS metal substrate cleaned with isopropanol before application.

Performance of the samples prepared as described above was evaluated as follows: The “dry touch performance” was developed from the “Set-to-Touch Time” (see U.S. Pat. No. 5,922,398). This test is similar to ASTM D¹⁶⁴⁰, which is a test for drying of organic coatings at RT. The paint compositions were applied to a non-porous substrate (metal panel) by suitable means to the specified film thickness. Measurements were taken after 2 h and 4 h by touching the wet paint films with the tip of a clean thumb. The ASTM method was modified in that the “set-to-touch” time in these examples was defined by the time it took for the wet paint to be tack-free in addition to having no paint adhering to the fingertip, leaving no finger print on the panel after a light touch. A mark of 1 was attributed to a completely dry coating, 3 to a coating that is dry but soft, and 5 to a wet coating

After 24 hours of curing at room temperature:
The Pendulum hardness (Persoz) was evaluated. It corresponded to the number of oscillations required for the pendulum amplitude to drop from 12° to 4° measured on a dried film. The harder the coating, the higher was the number of oscillations.
The high temperature resistance was assessed after exposing of the coated plate to heat on a hot plate following the below protocol:
   The oven temperature is increased from room temperature to 500° C. for one hour; then a 500° C. temperature plateau was maintained for 1 h. Then the cooling stage started for a couple of hours
   Evaluation of the coating discoloration was done using the so-called CIELAB color coordinates a*, b*, and L*, when specified in combination, describe the color of an object (under given or known viewing conditions), the measurement of the color deviation was then made according to ASTM D²²⁴⁴-21.
   Evaluation of the adhesion of the coating on the substrate was performed according to the DIN 2409 test method. The adhesion was reported in terms of % loss of material. The extent of cohesive failure was reported by the amount of material loss on the sticky tape (in the form of a picture).
   Evaluation of chalking was made by rubbing the coating 9 times with a finger. If chalking occurred, then some dark dust appeared on the finger and a “YES” was reported.

Results are shown below in Table 11.

TABLE 11
Emulsion Results

| | Emulsion of | | | | | | |
|---|---|---|---|---|---|---|---|
| | DOWSIL ™ CF- | Emulsion of | | | | | |
| Tested | 2405 | DOWSIL ™ US- | | | | | |
| Property | CE | CF-2403 Resin | CE2 | CE3 | CE4 | CE8 | CE9 |
| Dry touch 2 hrs | 3.5 | 4 | 4 | 4 | 4 | 3 | 3.5 |
| Dry touch 4 hrs | 3 | 4 | 4 | 3.5 | 4 | 3 | 3 |
| Hardness | 36.7 | 55 | 31.7 | 55.3 | 31.3 | 49 | 31.3 |
| Discoloration | 1.4 | 1.2 | 1.8 | 1.5 | 2 | 1 | 0.7 |
| Adhesion | 0% | <5% | 0% | 0% | 0% | 0% | <5% |
| before HT | | | | | | | |
| Adhesion after | 0% | <5% | 15-35% | 0% | <5% | 100% | 5-15% |
| HT | | | | | | | |
| Chalking | No | Yes | No | No | No | No | No |

| Tested Property | IE4 | IE5 | IE2 | IE7 | IE8 | IE9 |
|---|---|---|---|---|---|---|
| Dry touch 2 hrs | 3 | 3 | 3 | 3 | 3 | 3 |
| Dry touch 4 hrs | 2.5 | 3 | 3 | 3 | 3 | 3 |
| Hardness | 44.7 | 47 | 66 | 64.3 | 60.7 | 67 |
| Discoloration | 0.8 | 0.8 | 1.1 | 0.8 | 0.7 | 1.1 |
| Adhesion before HT | <5% | <5% | 0% | <5% | 0% | 0% |
| Adhesion after HT | 5-15% | 35-65% | 0% | 0% | 5-15% | <5% |
| Chalking | No | Yes | No | No | No | No |

All of the working examples tested showed better coating performance than the commercially available resins, DOWSIL™ US-CF-2403 and DOWSIL™ CF-2405; specifically, better (lower) dry hardness after 2 h indicating the alkoxy-functional silsesquioxane resins have fast cure times. Samples CE2 and IE4 show that when vinyl groups on the resin of CE2 are reacted with ETM converter to graft alkoxy groups using a spacer to place them away from the resin core, coating performance improved; specifically dry touch values decreased, hardness increased, Discoloration value decreased, and adhesion values before and after heat treatment changed less significantly for IE4 than for CE2 under the conditions tested. Samples CE3 and IE5 show that vinyl groups on the resin of CE3 were reacted with ETM converter to graft alkoxy groups using a spacer to place them away from the resin core, coating performance improved; specifically dry touch values decreased and Discoloration value decreased under the conditions tested. Dry touch values decreasing is an indicator of decreasing cure time (faster cure of the alkoxy-functional silsesquioxane resin), which is frequently desired by customers. Without wishing to be bound by theory, it is thought that emulsions with lower dry touch values cure faster, leading to faster processing speeds desired by customers. Furthermore, higher hardness of the cured film is also desired by customers. Without wishing to be bound by theory, the inventors surprisingly found that the silsesquioxane resin, which is in a liquid state under ambient conditions, can be emulsified easily into a silicone-in-water aqueous emulsion. And, this liquid resin will cure to form a solid film with good cure speed. Furthermore, these benefits can be achieved without adding organic solvent to the emulsion.

In this Reference Example 11, samples IE11 and IE12, emulsions were prepared as follows. IE7 was repeated to prepare an alkoxy-functional silsesquioxane resin. An emulsion was prepared by combining 66.6 weight parts of the alkoxy-functional silsesquioxane resin (prepared as described above for IE7) and 6.66 weight parts of Anionic Surfactant by blending with a dental mixer for 30 sec at 3600 rpm. Then water was added sequentially in an amount of 25.74 weight parts to generate an emulsion, and this was sample IE11. Sample IE12 was prepared the same way but with adding 1 weight part of Acrysol RM-2020 to the emulsion. The film appearance was nice and smooth. Each emulsion was formulated as a paint. The performance was evaluated as described herein and is shown below in Table 12.

TABLE 12

| Tested Property | IE11 | IE12 |
|---|---|---|
| Dry touch 2 hrs | 3 | 3 |
| Dry touch 4 hrs | 3 | 3 |
| Hardness | 51 | 81 |
| Discoloration | 1.5 | 1 |
| Adhesion before HT | 0% | 0% |
| Adhesion after HT | <5% | <5% |
| Chalking | No | No |

### Definitions and Usage of Terms

All amounts, ratios, and percentages herein are by weight, unless otherwise indicated by the context of specification. The articles ‘a’, ‘an’, and ‘the’ each refer to one or more, unless otherwise indicated by the context of specification. The singular includes the plural unless otherwise indicated by the context of specification. The SUMMARY and ABSTRACT are hereby incorporated by reference. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. Any feature or aspect of the invention may be used in combination with any other feature or aspect recited herein. The abbreviations used herein have the definitions in Table 13.

TABLE 13
Abbreviations

| Abbreviation | Description |
|---|---|
| ° C. | Degrees Celsius |
| CE | Comparative Example |
| D^{Me2} | A difunctional siloxane unit of formula (Me₂SiO_{2/2}) |
| DI | deionized |
| Dow | The Dow Chemical Company of Midland, Michigan, USA |
| Et | ethyl |
| FTIR | Fourier Transfer Infra Red |
| g | gram |
| GPC | gel permeation chromatography |
| h | hour |
| IE | Working Example |
| kPa | kilopascal |
| Me | methyl |
| M^{H} | A monofunctional siloxane unit of formula (HMe₂SiO_{1/2}) |
| M^{TM} | An alkoxy grafted monofunctional siloxane unit of formula |
| | (R^{TM}Me₂SiO_{1/2}), where R^{TM} is —C₂H₄Si(OMe)₃ |
| min | minute |
| mL | milliliter |
| mm | millimeter |
| mmHg | millimeters of mercury |
| Mn | Number average molecular weight measured by GPC |
| mol | mole |
| Mw | Weight average molecular weight measured by GPC |
| NVC | Non-volatile content |
| Oct | octyl |
| PDI | Polydispersity index |
| rpm | Revolutions per minute |
| RT | Room temperature of 23 ± 3° C. |
| sec | second |
| T^{DM} | An alkoxy grafted trifunctional siloxane unit of formula |
| | (R^{DM}SiO_{3/2}), where R^{DM} is —C₂H₄SiMe(OMe)₂ |
| T^{ETM} | An alkoxy grafted trifunctional siloxane unit of formula |
| | (R^{ETM}SiO_{3/2}), where R^{ETM} is a trimethoxysilylethyl- |
| | 1,1,3,3-tetramethyldisiloxy group |
| T^{Me} | A trifunctional siloxane unit of formula (MeSiO_{3/2}) |
| T^{Oct} | A trifunctional siloxane unit of formula (OctSiO_{3/2}) |
| T^{Vi} | A trifunctional siloxane unit of formula (ViSiO_{3/2}) |
| THF | tetrahydrofuran |
| μm | micrometer |
| Vi | vinyl |

### Test Methods

An example of a test method for determining hydrolyzable group content of a silsesquioxane resin is as follows. Hydrolyzable group content is analyzed by 29Si and 13° C. NMR in deuterated benzene. Total hydrolyzable content is determined from 29Si NMR analysis and is reported as a molar fraction based on Si units. The amount of this hydrolyzable group content that was methoxy is determined from 13C NMR analysis (1,4-dioxane is used as an internal standard). The difference between the total hydrolyzable group content and the amount of methoxy was the amount of OH groups present.

GPC Samples were prepared in certified THF at 1% w/w concentration, filtered with a 0.45 μm PTFE syringe filter, and analyzed against polystyrene standards. The relative calibration (3rd order fit) used for molecular weight determination was based on 12 polystyrene standards ranging in molecular weights from 580 to 1,735,000 Daltons. The chromatographic equipment consisted of a Viscotek GPCmax VE2001 Solvent/Sample Module equipped with a vacuum degasser, a Viscotek VE3580 RI detector, and two (300 mm×7.5 mm) Polymer Laboratories Mixed C columns (molecular weights separation range of 200 to 3,000,000) preceded by a guard column. The separation was performed using certified grade THF programmed to flow at 1.0 mL/min, injection volume was set at 100 μL and columns and detector were heated to 35° C. Data collection was 30 minutes and processing was performed using OmniSEC software.

Evaluation of the coating discoloration was done using the so-called CIELAB color coordinates a*, b*, and L*, when specified in combination, describe the color of an object (under given or known viewing conditions), the measurement of the color deviation was then made according to ASTM D2244-21.

1. An emulsion comprising:
I) a non-aqueous phase comprising A) an alkoxy-functional silsesquioxane resin;
II) an aqueous phase comprising water; and
III) a surfactant; wherein
the alkoxy-functional silsesquioxane resin comprises unit formula:
(R²₃SiO_{1/2})_{c}(R²₂SiO_{2/2})_{d}(R²SiO_{3/2})ₑ(ZO_{1/2})_{f}(HO_{1/2})_{g}; where
each R² is independently selected from the group consisting of an alkyl group and a group of formula (I) 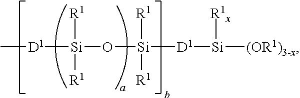
where in formula (I),
each R¹ is an independently selected alkyl group,
each D¹ is an independently selected alkylene group,
subscripts a, b, and x are integers with values such that
subscript a is 1 or 2,
subscript b is 0 or 1, and
subscript x is 0 or 1;
with the proviso that an average of 5 mol % to 25 mol % of R², per molecule, have formula (I);
subscripts c, d, and e represent mole fractions of each unit in the alkoxy-functional silsesquioxane resin and subscripts c, d, and e have values such that
$$0 \leq c \leq 0.25 ,$$
$$0 \leq d \leq 0.20 ,$$
$$0.55 < e \leq 1 , and$$
$$a quantity ( c + d + e ) = 1 ;$$
each Z is an independently selected alkyl group; and
subscript f represents a molar amount of alkoxy groups in the resin, and subscript g represents a molar amount of hydroxyl groups in the resin, and subscripts f and g have values such that
$$0.01 \leq f \leq 0.7 ;$$
$$0 \leq g \leq 0.05 ; and$$
$$0.02 \leq ( f + g ) \leq 0 \text{.75} ;$$
where the alkoxy-functional silsesquioxane resin is in a liquid state at 23° C.±3° C. and 101.325 kPa.

2. The emulsion of claim 1, where in A) the alkoxy-functional silsesquioxane resin,
subscript a=1,
subscript b=1,
each D¹ has empirical formula —C₂H₄—,
each R¹ is methyl,
each R² that is not a group of formula (I) is methyl, and
each Z is independently selected from the group consisting of methyl and ethyl.

3. The emulsion of claim 1, where in A) the alkoxy-functional silsesquioxane resin,
subscript b=0,
each D¹ has empirical formula —C₂H₄—,
each R¹ is methyl,
each R² that is not a group of formula (I) is methyl, and
each Z is independently selected from the group consisting of methyl and ethyl.

4. The emulsion of claim 1, where in A) the alkoxy-functional silsesquioxane resin, R² has formula (I) in at least one instance of the unit (R²SiO_{3/2}), per molecule.

5. The emulsion of claim 1, where the alkoxy-functional silsesquioxane resin has a weight average molecular weight of 1,000 g/mol to 15,000 g/mol measured by gel permeation chromatography.

6. The emulsion of claim 1, where III) the surfactant comprises an anionic surfactant.

7. The emulsion of claim 6, where III) the surfactant comprises sodium lauryl sulfate.

8. The emulsion of claim 1, where the emulsion comprises:
50 weight % to 80 weight % of I) the alkoxy-functional silsesquioxane resin,
15 weight % to 40 weight % of II) water, and
2 weight % to 10 weight % of III) the surfactant,
each based on combined weights of all starting materials in the emulsion.

9. The emulsion of claim 1, where the composition is substantially free of organic solvent.

10. The emulsion of claim 1, further comprising an additional starting material selected from the group consisting of: a condensation reaction catalyst, a coupling agent, an antistatic agent, an ultraviolet (UV) stabilizer, a plasticizer, a leveling agent, a preservative, a foam booster, a deposition agent, a thickener, a water phase stabilizing agent, a filler, a suspending agent, a biocide, a freeze/thaw additive, an anti-freeze agent, a viscosity modifier, a defoamer, a compatibilizer, a dyestuff, a binder, an antioxidant, a flame retardant, and a combination of two or more thereof.

11. The emulsion of claim 1, further defined as a paint composition and further comprising an additional starting material selected from the group consisting of a dyestuff, a defoamer, a filler, and a combination of two or more thereof.

12. A method of preparing the emulsion of claim 1, said method comprising:
combining starting materials comprising the alkoxy-functional silsesquioxane resin, water, and the surfactant to give a combination; and
shearing the combination, thereby preparing the emulsion.

13. A method of preparing a film, where the method comprises:
1) applying the emulsion of claim 1 on a substrate,
2) forming the film on the substrate from the emulsion.

14. The method of claim 13, where forming the film on the substrate comprises
forming a wet film on the substrate and
drying the wet film on the substrate to form the film, wherein drying the wet film comprises
(i) evaporating water form the wet film,
(ii) exposing the wet film to an elevated temperature to drive water therefrom,
(iii) curing the wet film, or
(iv) any combination of (i) to (iii).

15. A film prepared by the method of claim 14.
